(19) United States
(12) Patent Application Publication
(10) Pub. No.: US 2026/0100968 A1
(43) Pub. Date: Apr. 9, 2026

(54) SYSTEMS AND METHODS FOR AUTONOMOUS CYBER RISK REMEDIATION

(71) Applicant: RTX Corporation, Arlington, VA (US)

(72) Inventors: Patrick Duessel, Madison, CT (US); Mark D. Leistner, Covington, OH (US); Justin Robert Scott, San Antonio, TX (US); Andrew Michael Krycerick, Hartford, CT (US); Brett M. Ferrante, West Hartford, CT (US); Tavis J. Gillard, Wylie, TX (US); Troy A. Cottle, Murphy, TX (US)

(21) Appl. No.: 19/348,969

(22) Filed: Oct. 3, 2025

Related U.S. Application Data
(60) Provisional application No. 63/702,995, filed on Oct. 3, 2024.

(51) Int. Cl. H04L 9/40

(52) U.S. Cl. CPC H04L 63/1433; H04L 63/1441

(57) ABSTRACT

A method includes aggregating network data associated with assets included in the network and associated with an organization, extracting defect features associated with the assets based on control data associated with the network and asset data associated with the assets, extracting threat features related to the organization, an industry associated with the organization, or the assets, determining risk information respectively associated with the assets based on the extracted threat features and the extracted defect features, generating a network graph based on the aggregated network data and the risk information, wherein each node in the network graph represents a respective asset included in the network, performing an automated analysis of the network graph, and generating a task plan based on performing the automated analysis of the network graph. Generating the task plan includes prioritizing individual assets or sets of connected assets in a defined neighborhood of the network.

### CROSS-REFERENCE TO RELATED APPLICATIONS

This application claims the benefit of U.S. Application No. 63,702,995 filed Oct. 3, 2024, the disclosure of which is incorporated herein by reference in its entirety.

### BACKGROUND

Exemplary embodiments of the present disclosure pertain to the art of vulnerability management and, in particular, cyber threat risk. Embodiments of the present disclosure support a system and method for prioritizing cyber risk using risk-colored network graphs.

Vulnerability management can include systems and methods that keep computer systems, networks, and enterprise applications safe from cyberattacks and data breaches. The processes can be autonomous in some instances and typically are continuous.

### BRIEF DESCRIPTION

Disclosed are systems and methods of minimizing cyber risk in computing environments through continuous assessment of cyber control efficacy and prioritized resolution of most critical defects.

Example embodiments of the present disclosure are directed to a method of surgically and effectively remediating risk associated with assets included in a network in association with increasing risk reduction impact, including: aggregating network data associated with the assets included in the network, wherein the assets are associated with an organization; extracting defect features associated with the assets based on control data associated with the network and asset data associated with the assets; extracting threat features related to the organization, an industry associated with the organization, or the assets; determining risk information respectively associated with the assets based on the extracted threat features and the extracted defect features; generating a network graph based on the aggregated network data and the risk information, wherein each node in the network graph represents a respective asset included in the network; performing an automated analysis of the network graph; and generating a task plan based on performing the automated analysis of the network graph, wherein generating the task plan includes prioritizing individual assets or sets of connected assets in a defined neighborhood of the network.

In any one or combination of the embodiments disclosed herein, the network data includes network flow information and device connectivity information among the assets.

In any one or combination of the embodiments disclosed herein: the control data includes an indication of software vulnerabilities, device configuration defects, and security tool defects associated with the network, and the asset data includes an inventory of the assets and incident data associated with the assets.

In any one or combination of the embodiments disclosed herein: determining the risk information includes mapping the extracted defect features to normalized risk scores using a risk mapping function, and the risk information includes the normalized risk scores.

In any one or combination of the embodiments disclosed herein, the individual assets or the sets of connected assets in the defined neighborhood have a relatively high risk and high importance compared to other assets included in the defined neighborhood.

In any one or combination of the embodiments disclosed herein, the method further includes: determining a likelihood of a threat associated with an asset included in the network; and determining a control strength associated with the asset and the threat, wherein the control strength is a measure of an efficacy of a control associated with mitigating the threat, wherein determining the risk information includes calculating a risk of exposure for the asset based on: the likelihood of the threat associated with the asset; and the control strength associated with the asset and the threat.

In any one or combination of the embodiments disclosed herein, the method further includes: displaying each node in the network graph with a color indicative of a risk of exposure for an asset represented by the node, wherein the method includes determining the color according to which to display each node, based on a set of candidate risk indicators and a defined threat model; and displaying directional arrows between nodes in the network graph, wherein: a directional arrow between two nodes represents an observed direction of data flow between assets represented by the two nodes, and the directional arrow is displayed with a color and a label according to an amount of the data flow between the two nodes.

In any one or combination of the embodiments disclosed herein, the method further includes identifying, based on performing the automated analysis, a target area of the network graph having a risk density which exceeds a threshold risk density, wherein the task plan includes one or more actions associated with reducing risk with respect to the target area.

In any one or combination of the embodiments disclosed herein: the target area is a closed k-neighborhood of a node included in the network graph; and the risk density of the target area is based on a concentration of risks associated with other nodes included in the target area, wherein the other nodes are directly or indirectly connected to the node within a defined distance which defines the closed k-neighborhood.

In any one or combination of the embodiments disclosed herein, the method further includes: identifying, based on performing the automated analysis, a target node which is included in the network graph and has a risk propagation value which exceeds a threshold risk propagation value, wherein the risk propagation value is a measure of a degree of a risk spreading through the network graph via the target node, wherein the task plan includes one or more actions associated with reducing risk with respect to the target node.

In any one or combination of the embodiments disclosed herein, the method further includes identifying, based on performing the automated analysis, a target area of the network graph including nodes having respective control deficiencies similar to one another, wherein the task plan includes one or more actions associated with reducing risk with respect to the target area.

In any one or combination of the embodiments disclosed herein, the method further includes: determining, based on performing the automated analysis, one or more actions associated with reducing the risk with respect to the network; determining a probability of an adverse impact associated with implementing the one or more actions; and incorporating the one or more actions into the task plan based on the probability.

In any one or combination of the embodiments disclosed herein, the method further includes: determining an asset importance for each asset included among the assets using a crown-centrality measure, wherein the crown-centrality measure is based on a proximity of the asset to a target asset among the assets, wherein the target asset has one or more of a relatively highest value, a relatively highest strategic importance, or a relatively highest performance compared to remaining assets among the assets, wherein generating the task plan is based on the asset importances determined for the assets.

Example embodiments of the present disclosure are also directed to a system configured to: aggregate network data associated with assets included in a network; extract defect features associated with the assets based on control data associated with the network and asset data associated with the assets; extract threat features related to the organization, an industry associated with the organization, or the assets; determine risk information respectively associated with the assets based on the extracted threat features and the extracted defect features; generate a network graph based on the aggregated network data and the risk information, wherein each node in the network graph represents a respective asset included in the network; perform an automated analysis of the network graph; and generate a task plan based on performing the automated analysis of the network graph, wherein in generating the task plan, the system is configured to prioritize individual assets or sets of connected assets in a defined neighborhood of the network.

In some aspects, the techniques described herein relate to a system, wherein the network data includes network flow information and device connectivity information among the assets.

In some aspects, the techniques described herein relate to a system, wherein: the control data includes an indication of software vulnerabilities, device configuration defects, and security tool defects associated with the network, and the asset data includes an inventory of the assets and incident data associated with the assets.

In some aspects, the techniques described herein relate to a system, wherein: determining the risk information includes mapping the extracted defect features to normalized risk scores using a risk mapping function, and the risk information includes the normalized risk scores.

In some aspects, the techniques described herein relate to a system, wherein the individual assets or the sets of connected assets in the defined neighborhood have a relatively high risk and high importance compared to other assets included in the defined neighborhood.

In some aspects, the techniques described herein relate to a system, further including identifying, based on performing the automated analysis, at least one of: a target area of the network graph having a risk density which exceeds a threshold risk density; a target node which is included in the network graph and has a risk propagation value which exceeds a threshold risk propagation value, wherein the risk propagation value is a measure of a degree of a risk spreading through the network graph via the target node; or a second target area of the network graph including nodes having respective control deficiencies similar to one another, wherein the task plan includes one or more actions associated with reducing risk with respect to the at least one of the target area, the target node, or the second target area.

Example embodiments of the present disclosure are also directed to an apparatus including: a memory having computer readable instructions and one or more processors for executing the computer readable instructions, wherein the computer readable instructions, when executed by the one or more processors, cause the apparatus to: aggregate network data associated with assets included in a network; extract defect features associated with the assets based on control data associated with the network and asset data associated with the assets; extract threat features related to the organization, an industry associated with the organization, or the assets; determine risk information respectively associated with the assets based on the extracted threat features and the extracted defect features; generate a network graph based on the aggregated network data and the risk information, wherein each node in the network graph represents a respective asset included in the network; perform an automated analysis of the network graph; and generate a task plan based on performing the automated analysis of the network graph, wherein in generating the task plan, the apparatus is configured to prioritize individual assets or sets of connected assets in a defined neighborhood of the network.

### BRIEF DESCRIPTION OF THE DRAWINGS

The following descriptions should not be considered limiting in any way. With reference to the accompanying drawings, the attached figures are incorporated herein by reference.

FIG. 1 illustrates a general overview of a process for cyber assurance according to an embodiment.

FIG. 2 illustrates some factors which may affect vulnerability management.

FIG. 3A illustrates an example system supportive of cyber risk remediation in accordance with one or more embodiments of the present disclosure.

FIG. 3B illustrates an example system supportive of cyber risk remediation in accordance with one or more embodiments of the present disclosure.

FIGS. 4A and 4B illustrates an example of a risk-colored network graph provided by the systems and techniques described herein in accordance with one or more embodiments of the present disclosure.

FIG. 5A illustrates an example of a risk scoring provided by the systems and techniques described herein in accordance with one or more embodiments of the present disclosure. FIG. 5B illustrates examples of control indicators in accordance with one or more embodiments of the present disclosure.

FIG. 6 illustrates an example of centrality measures used by a system in determining asset importance, in accordance with one or more embodiments of the present disclosure.

FIG. 7A illustrates aspects of risk density as calculated using the systems and techniques described herein.

FIGS. 7B and 7C illustrate aspects of risk propagation as calculated using the systems and techniques described herein.

FIG. 8 illustrates an example risk prioritization graph generated by a system in accordance with one or more embodiments of the present disclosure.

FIG. 9 illustrates an example method of quantifying total risk of exposure and risk reduction impact in accordance with one or more embodiments of the present disclosure.

FIG. 10 illustrates experimental results achieved using the systems and techniques described herein in accordance with one or more embodiments of the present disclosure compared to other approaches.

FIG. 11 illustrates graphs comparing results achieved using risk-based surgical remediation and risk reduction impact supported by the present disclosure against results achieved using some other techniques or campaigns.

FIG. 12 illustrates graphs comparing results achieved using risk-based surgical remediation and risk reduction impact supported by the present disclosure against results achieved using some other techniques or campaigns.

FIG. 13 illustrates an example method supportive of risk modeling in accordance with one or more embodiments of the present disclosure.

FIGS. 14 through 16 illustrate example tables of information included in the threat model, the threat control mapping, and the control-risk indicator mapping.

FIG. 17 illustrates examples of prioritization strategies and centrality measures based on which asset importance can be determined in accordance with one or more embodiments of the present disclosure.

FIG. 18 is a block diagram of a distributed computer system, in which various aspects and functions discussed herein may be practiced.

FIG. 19 illustrates an example flowchart of a method in accordance with one or more embodiments of the present disclosure.

### DETAILED DESCRIPTION

A detailed description of one or more embodiments of the disclosed apparatus and method are presented herein by way of exemplification and not limitation with reference to the Figures.

Vulnerability management is a challenging discipline. For example, enterprise networks are oftentimes complex and subject to dynamic changes. Every system in a network can be subject to many different types of vulnerabilities, ranging from hardware and software vulnerabilities to system configuration defects. Remediating vulnerabilities in large organizations can be laborious, time consuming, and oftentimes ineffective, resulting in a waste of valuable company resources while oftentimes not providing adequate risk reduction. An approach is desired which drives effective risk reduction with a minimum amount of resources to account for competing priorities, and fast developing threats.

In accordance with one or more embodiments of the present disclosure, an innovative approach is provided which holistically gauges systemic cyber risk by leveraging risk-colored network graphs. By overlaying existing asset, defect and network flow information, the approach supports concise identification of risk density and risk propagation areas in large computer networks, thereby enabling an organization to address current and emerging areas of high risk more effectively and efficiently in near real-time. As will be described herein, an intelligent approach is provided which may prioritize remediation activities and effectively focus cyber risk reduction on portions of a network where the risk reduction will have relatively the highest impact.

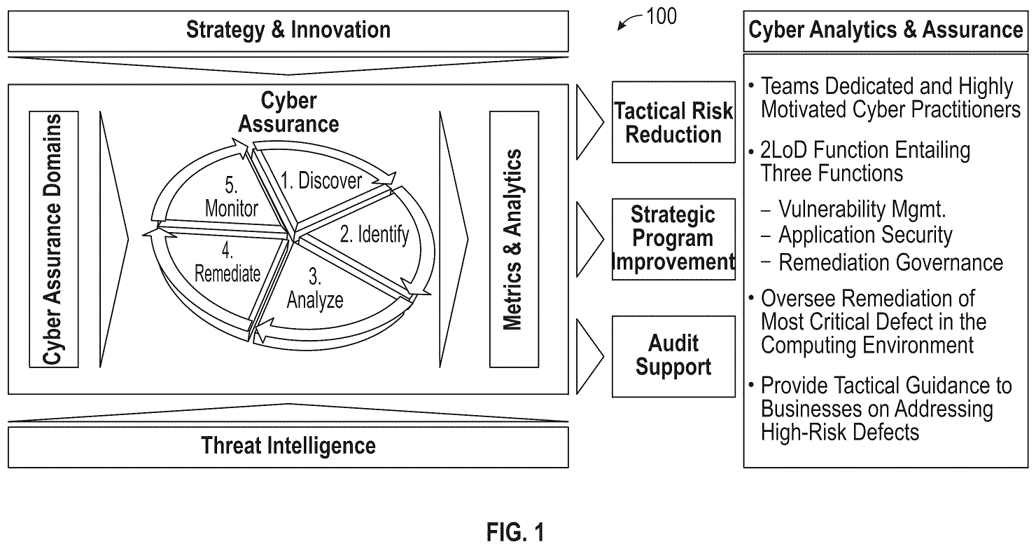

FIG. 1 illustrates a general overview of a process 100 for cyber assurance according to an embodiment. The process 100 supports minimizing cyber risk in computing environments through continuous assessment of cyber control efficacy and oversight over resolution of most critical defects.

The process 100 may include cyber assurance, cyber assurance domains, strategy and innovation, threat intelligence, tactical risk reduction, strategic program improvement, and audit support. Cyber assurance may include discovery, identification, analysis, remediation, and monitoring of risks and assets for cyber assurance domains. Cyber assurance may output metrics and analytics data for performing targeted risk reduction actions. Performing tactical risk reduction, strategic program improvement, and audit support may provide cyber analytics and assurance.

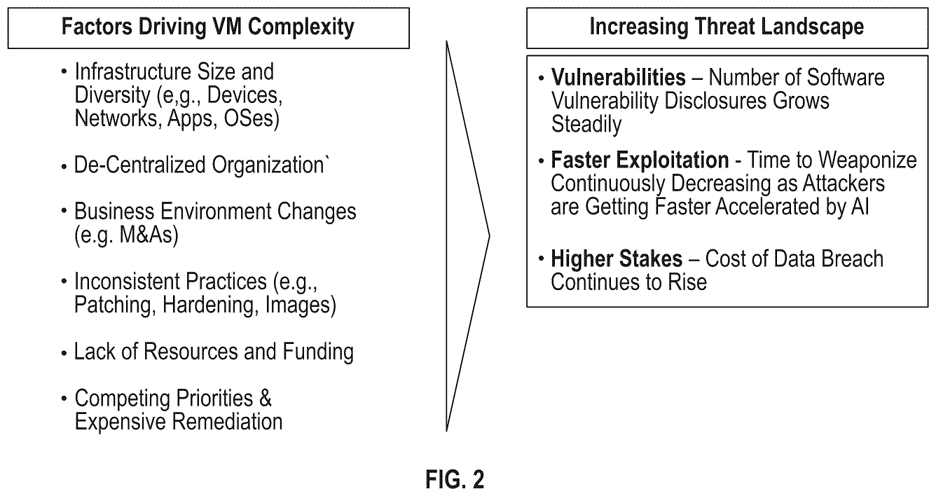

FIG. 2 illustrates some factors which may affect vulnerability management. Example factors driving vulnerability management complexity include infrastructure size and diversity (e.g., devices, networks, apps, OSes), degree of centralization, business environment changes (e.g. mergers and acquisitions), inconsistent security practices (e.g., patching, hardening, images), limited resources and funding, and competing priorities and expensive remediation.

Example velocity factors driving speed of decision-making and action in vulnerability management include continuously increasing number of vulnerability disclosures and faster exploitation of vulnerabilities through proliferation and adoption of emerging technologies including, but not limited to, Artificial Intelligence as well as continuously rising cost of data breaches.

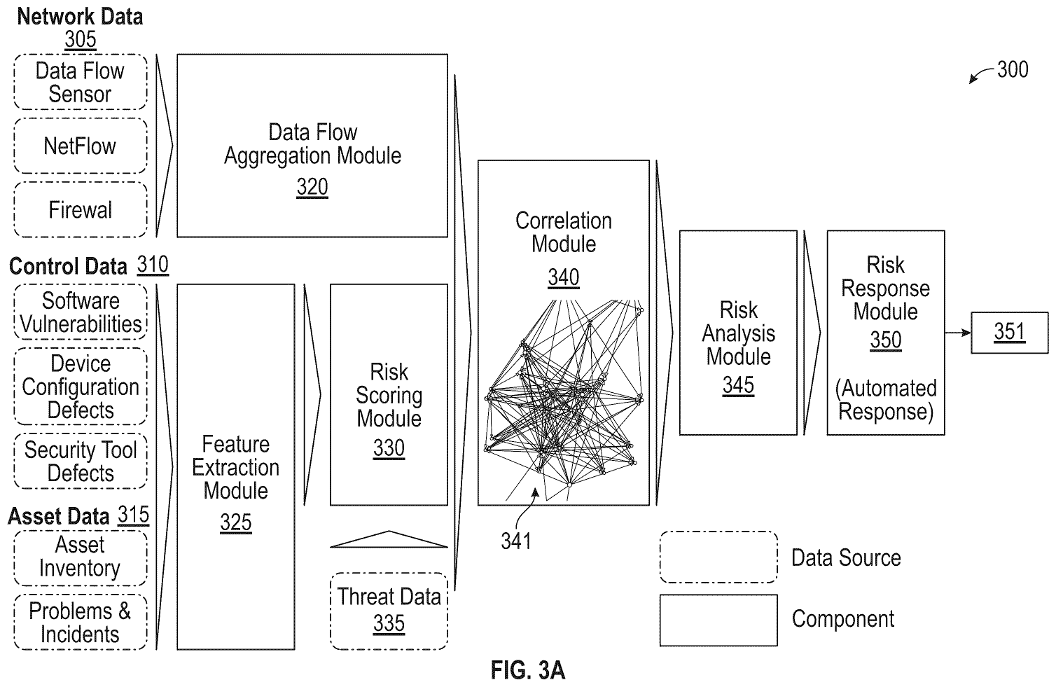

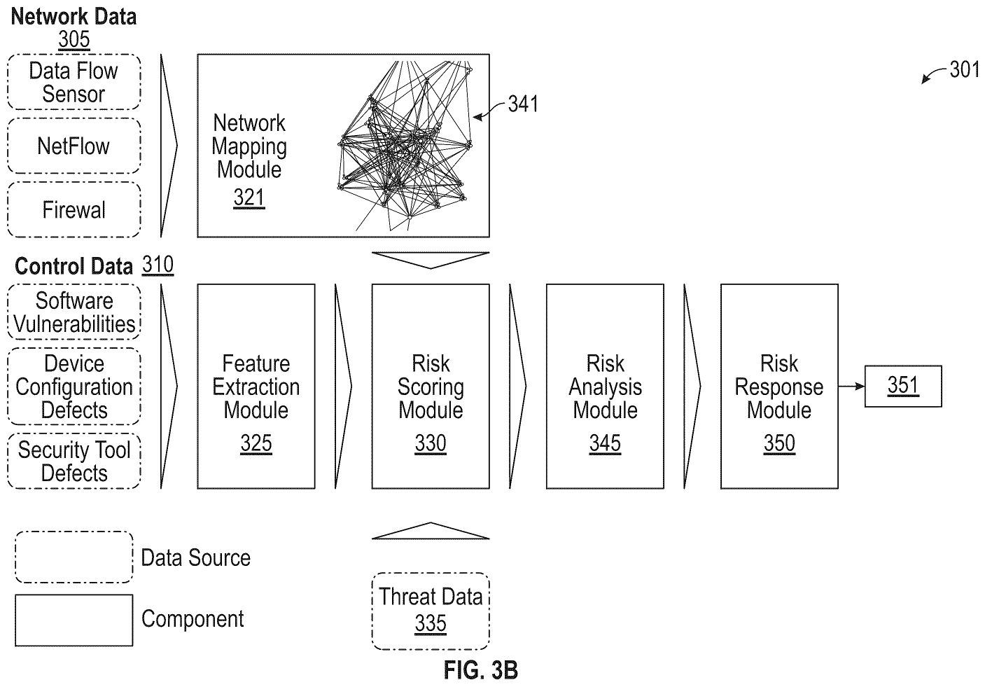

FIG. 3A illustrates an example system 300 supportive of cyber risk remediation in accordance with one or more embodiments of the present disclosure. The system 300 may be implemented by a distributed computer system 1800 later described herein. The example system 300 is a high-level example, and embodiments of the present disclosure are not limited to the example.

As will be described herein, the system 300 supports vulnerability management capable of quantifying cyber risk based on an organization specific cyber threat model. In some embodiments, the system 300 may prioritize vulnerabilities across different cyber assurance domains. The system 300 may generate a risk-colored network graph via which the system 300 overlays cyber risk on computing nodes in a network with data flow information obtained from the devices, thus providing a more concise and holistic identification and prioritization of vulnerabilities based on cyber risk and importance of an compute node in a network compared to other approaches. The system 300 may measure risk through a defined set of control indicators mapped to mitigations, and in turn map the mitigations to cyber threat vectors. A single mitigation can counteract one or many threat actors. A single control indicator can measure the efficacy of one or many mitigations.

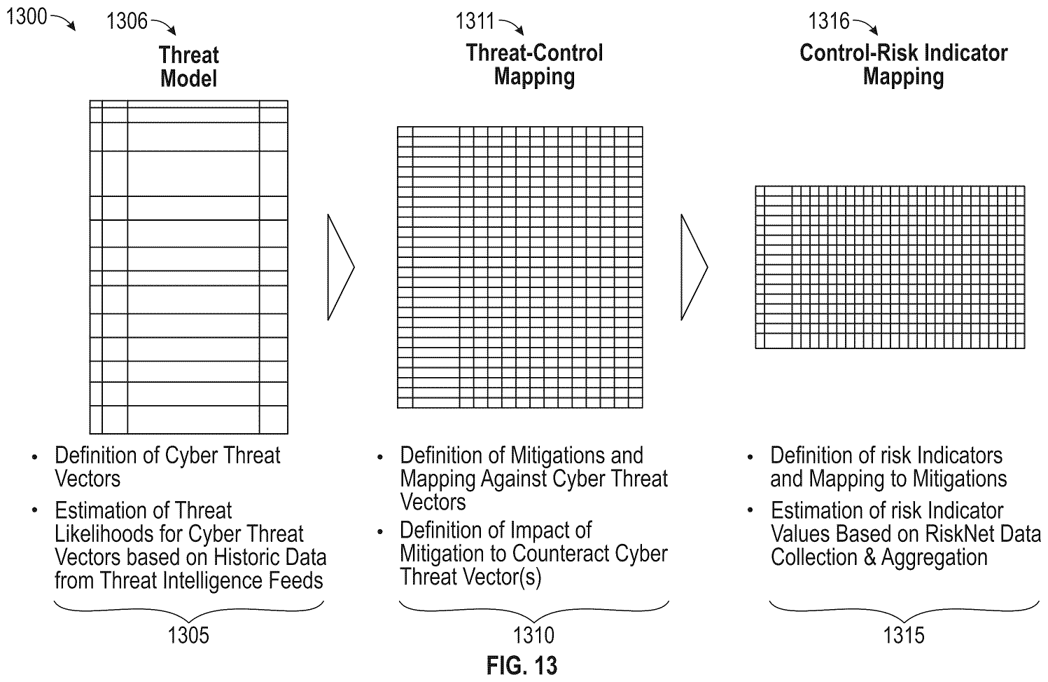

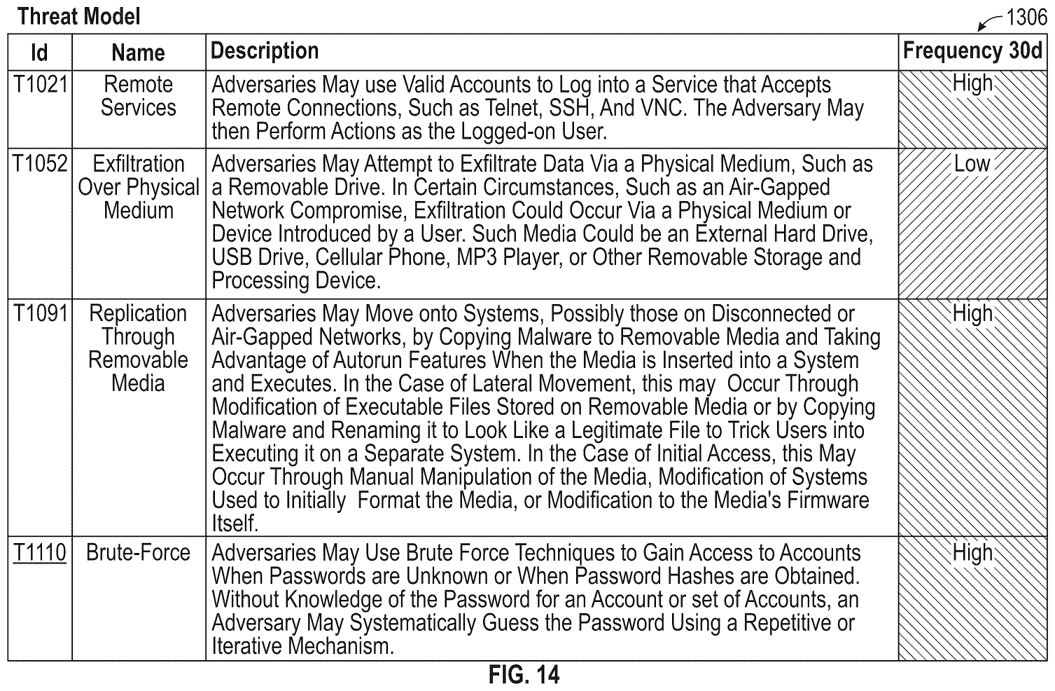

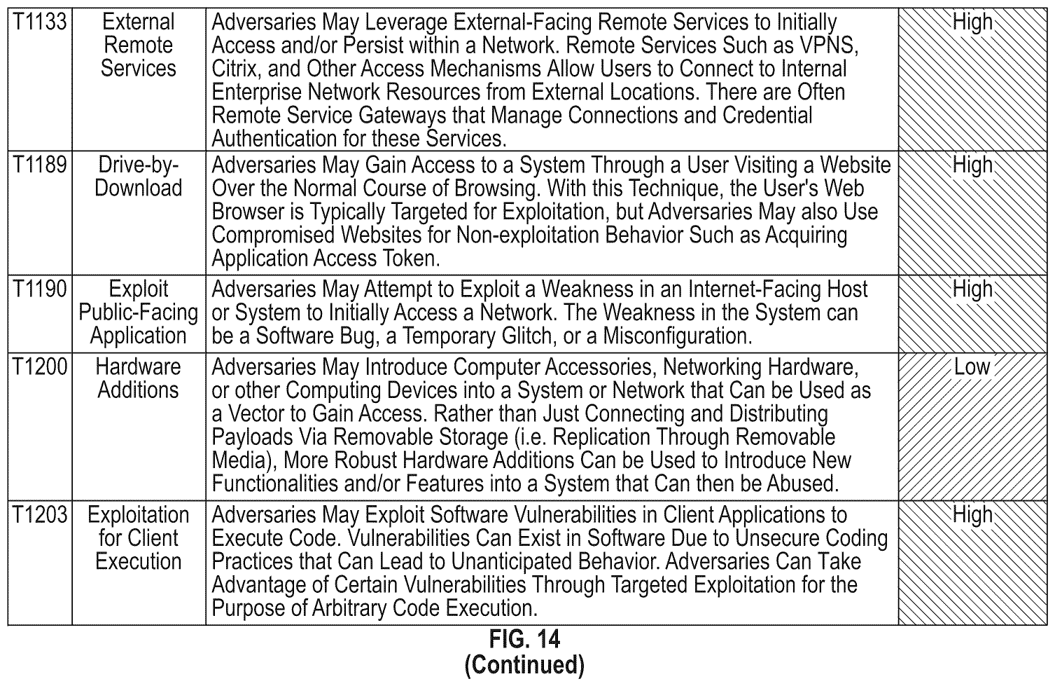

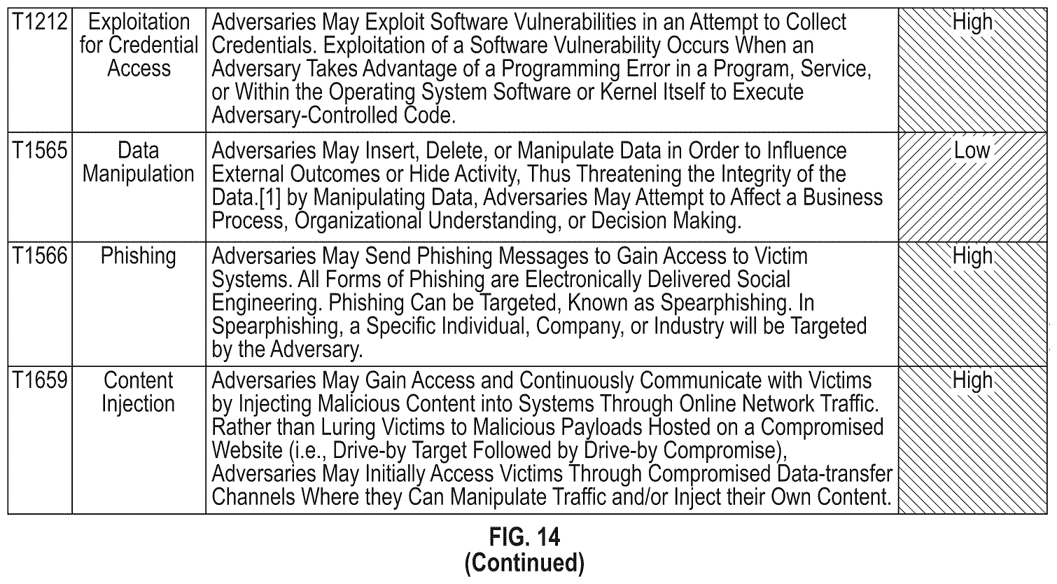

The system 300 includes a data flow aggregation module 320, a feature extraction module 325, a risk scoring module 330, a correlation module 340, a risk analysis module 345, and a risk response module 350. The system 300 may process data received from data sources (e.g., network data 305, control data 310, asset data 315, threat data 335) included in or accessible to the system 300. For example, the system 300 may process network data 305, control data 310, asset data 315, and threat data 335 and accordingly determine a risk response 351. Threat data 335 includes threat vectors and their estimated threat likelihood (e.g. brute-force, exploit public-facing applications). Threat likelihood is based on measuring frequency of observations within a defined time frame W. The relative frequency of seeing a threat vector is determined by the number of observations of a particular threat vector divided by the total number of observations in a defined time frame W. Non-limiting examples of the threat data 335 are described with reference to threat model 1306 at FIGS. 13 and 14.

In some aspects, the system 300 may generate and output a return on investment (impact) calculation associated with implementing the risk response 351. Example details of the operations performed by the system 300 are further described herein.

The system 300 may identify, prioritize, and action systemic cyber risk in a computer network of an organization by overlaying network data flow information with defect information about individual computing devices on the computer network.

The data flow aggregation module 320 may collect network data 305 about computing devices connecting from, and to other computing devices in or outside of the computer network. In some aspects, the data flow aggregation module 320 may include or access a plurality of sensors (e.g., data flow sensors, network flow sensors) which provide the network data 305. The network data 305 may include network information and network flow information of the computer network.

For example, the network data 305 may include data flow logs, NetFlow logs, network firewall logs, host firewall logs, and custom data logging executed through an autonomous endpoint management (AEM) platform. The data flow aggregation module 320 may determine a unique asset identifier for each computing device based on a lookup an IP address, hostname, or fully qualified domain name (FQDN) associated with the computing device, in a record of computing devices provided by an authoritative source.

The feature extraction module 325 may extract features based on control data 310 and asset data 315. The control data 310 may include software vulnerabilities, device configuration vulnerabilities, and endpoint security tool defects, but are not limited thereto. The asset data 315 may include an asset inventory and data indicating problems and incidents (e.g., current or historical problems and incidents) associated with assets included in the asset inventory, but are not limited thereto. In some examples, the feature extraction module 325 may extract defect features representative of control states of compute nodes (e.g., computing devices) in the network.

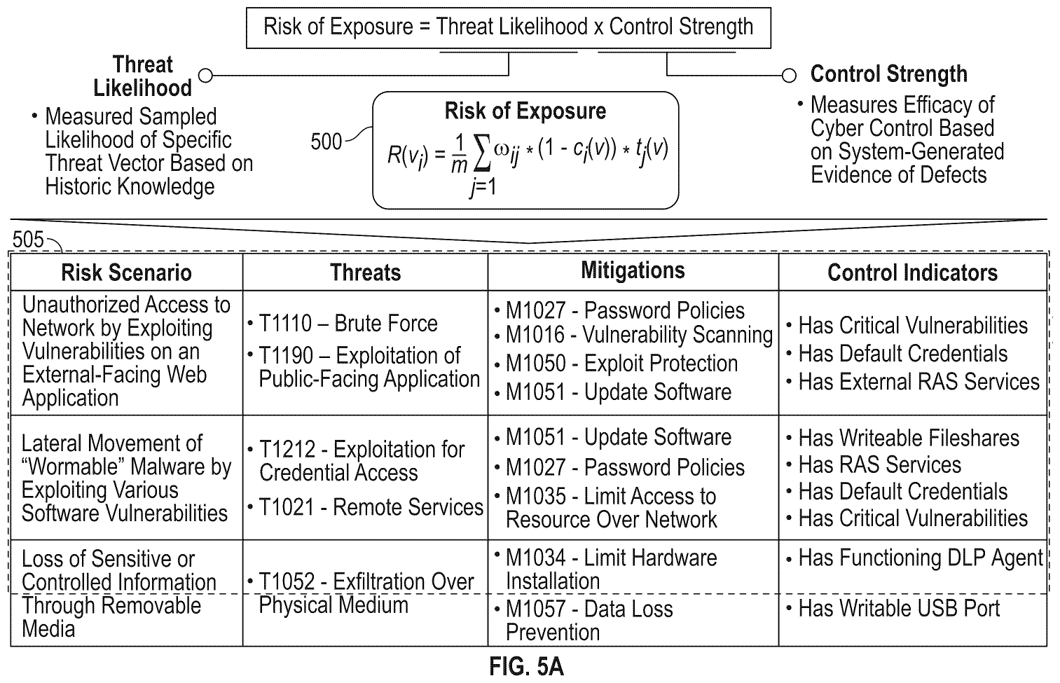

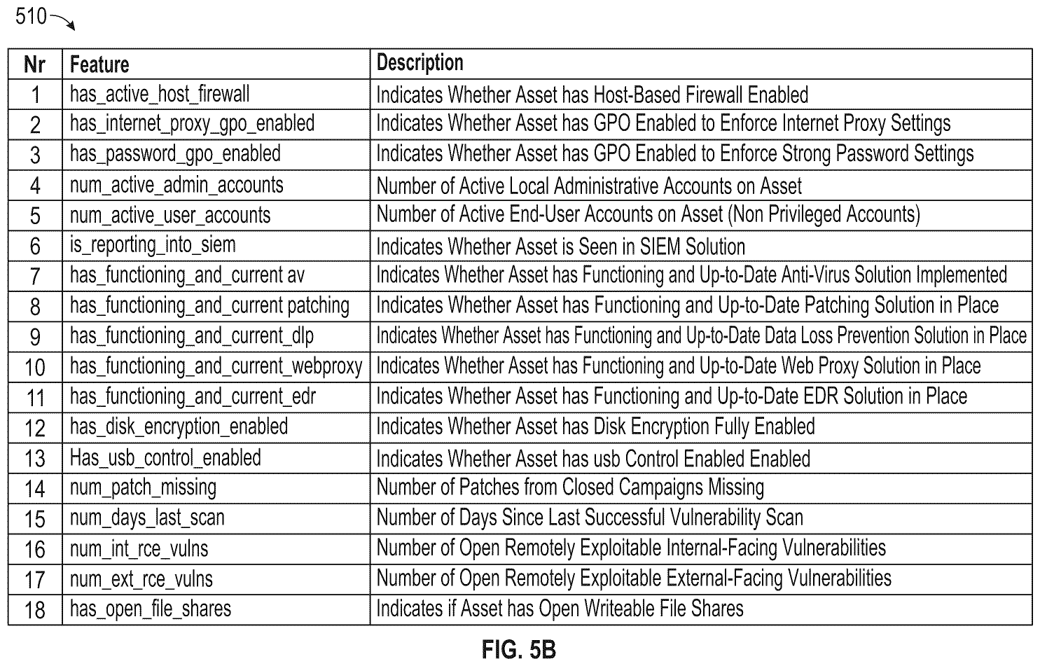

The risk scoring module 330 may determine or calculate risk for each compute node in the network. In an example, the risk scoring module 330 may represent the risk of each compute node using a cyber risk score and change risk score. A cyber risk score may be calculated in accordance with risk of exposure 500 later described with reference to FIG. 5A. In an example, using a cyber risk mapping function included among a set of defined cyber risk mapping functions, the risk scoring module 330 may map extracted defect features (as provided by the feature extraction module 325) representing the control efficacy state of a compute node to a normalized cyber risk score, taking into account a set of threats applicable to the compute environment.

A cyber risk mapping function is a combination of Boolean expressions of one or many vulnerability features applicable to specific device types. The change risk score provided by the risk scoring module 330 may be used by the system 300 for determining the probability of adverse impact (or alternatively, a positive impact) of a configuration change on a computing node to remediate a particular vulnerability as a result of a risk response 351. A risk response 351 is defined as an action associated with reducing risk. Risk responses 351 (e.g., an action, such as a change on a compute node) may include, but are not limited to, deploying patches, changing security configurations, changing routing paths, disabling users, disabling services, disabling ports, and uninstalling software.

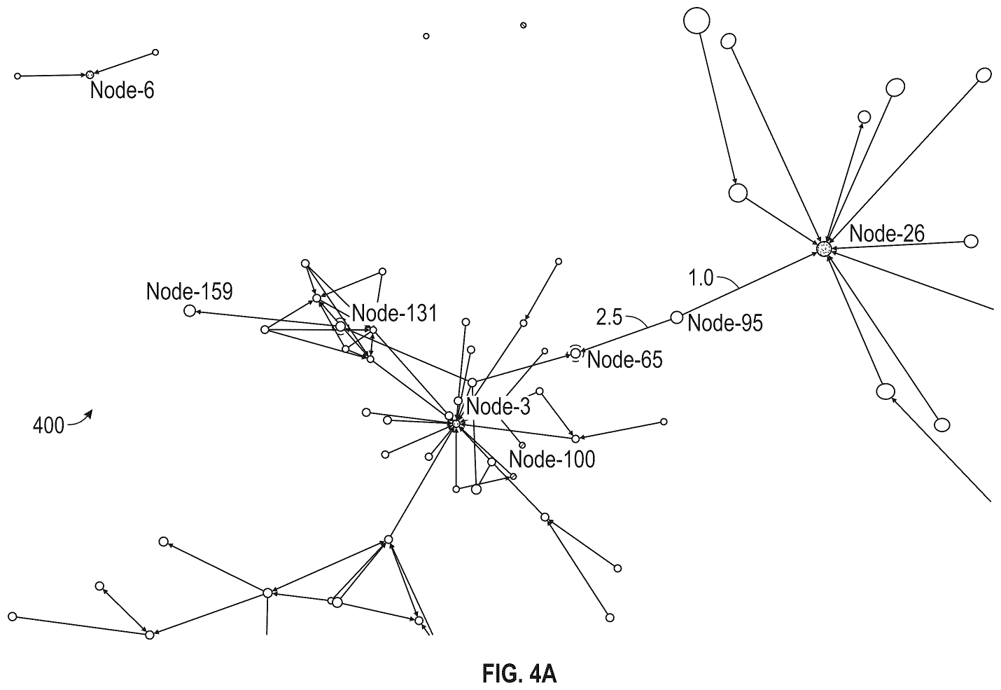

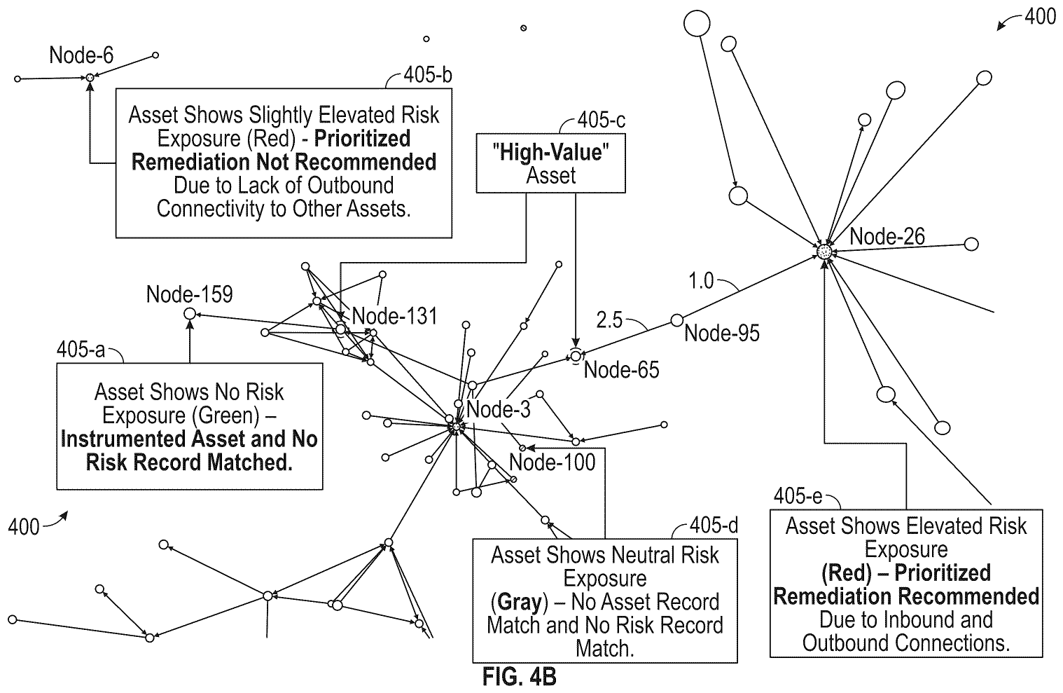

The correlation module 340 may overlay and combine data flow information with risk information via a unique asset identifier, which may thereby provide a risk-colored network graph 341. Example aspects of the risk-colored network graph 341 as generated by the system 300 is later described with reference to FIGS. 4A and 4B.

The risk analysis module 345 may perform an automated analysis of the risk-colored network graph 341 at defined intervals. Based on the automated analysis, the risk analysis module 345 may identify areas of connected elevated risk in the computing network, expressed through risk density (i.e., an area of the risk-colored network graph 341 having a risk density which exceeds a threshold risk density) as well as risk propagation (i.e., nodes having a risk propagation value which exceeds a threshold risk propagation value). For example, as part of the automated analysis, the risk analysis module 345 may identify individual compute nodes of sets of individual compute nodes with defects that are contributing most to the overall cyber risk in the computing network. In some aspects, the risk analysis module 345 may identify the compute nodes by solving a constrained optimization problem.

The risk response module 350 may evaluate cyber risk and change risk as determined by the risk analysis module 345 and define a task plan based on the cyber risk and change risk. The task plan may be included in the risk response 351. The task plan may include an action (or actions) for addressing the cyber risk, along with an indication of whether each of the actions is to be executed manually or executed automatically. In some aspects, the risk response module 350 may define whether an action is to be executed manually or automatically, based on the change risk level for involved compute nodes.

In some aspects, the system 300 may feed automated actions (i.e., actions to be executed automatically) into a security orchestration, automation and response (SOAR) action queue. The system 300 may automatically feed manual actions (i.e., actions to be executed manually) into a ticket system for manual remediation.

FIG. 3B illustrates an example system 301 supportive of cyber risk remediation in accordance with one or more embodiments of the present disclosure. The system 301 includes aspects of the system 300, and repeated descriptions of like elements are omitted for brevity. The system 301 includes a network mapping module 321. The network mapping module 321 may implement features of the data flow aggregation module 320 and correlation module 340 described with reference to FIG. 3A. Aspects described herein may be interchangeably applied between the network mapping module 321 and the aggregation module 320 and the correlation module 340.

FIGS. 4A and 4B illustrates an example of a risk-colored network graph 400 provided by the systems and techniques described herein in accordance with one or more embodiments of the present disclosure. The risk-colored network graph 400 illustrates aspects of the risk-colored network graph 341 described with reference to FIGS. 3A and 3B. The system 300 may generate the risk-colored network graph 341 through network mapping performed by the network mapping module 321 (and/or by the correlation module 340) described with reference to FIGS. 3A and 3B.

During network mapping, the network mapping module 321 may generate a network graph 400 based on monitored activity in the network. For example, the network mapping module 321 may generate the risk-colored network graph 400 based on the network data 305. The network data 305 may be provided via various data sources such as, for example, device and network firewalls logs, Netflow logs, as well as well as customized sensors (e.g., data flow sensors, network flow sensors) executed on instrumented devices on the network. The data sources may collect and provide communication metadata and device configuration data to the network mapping module 321. Communication metadata includes but is not limited to timestamps, source IP, destination IP, destination port, protocol, packets sent, packets received. Communication meta data is collected at defined snapshot intervals multiple times a day, stored locally and transferred to a defined set of central servers on the network in an aggregated fashion for permanent storage.

The risk-colored network graph 400 may be a risk-colored network graph. For example, the risk-colored network graph 400 may be a directed acyclic network graph G representative of the computing network and including a set of vertices V and a set of edges E, where:

G=(V,E) and E={(x,y)|(x,y)∈V² and x≠y} and each vertex v is represented by a risk score 0≤R(v)≤1.

Each vertex v represents a device (compute node) in the computing network, and each edge E represents a data flow observed (through instrumentation) between two adjacent devices in the network.

The nodes displayed in the risk-colored network graph 400 by the system 300 correspond to devices seen active on the network within the last N days (where N is an integer value). The system 300 applies a node color to each node based on the quantified cyber risk associated with the node. In some aspects, the system 300 may calculate the cyber risk for each node based on a set of control indicators and a defined threat model. Control indicators can include but are not limited to number of certain vulnerabilities found on the system, efficacy of endpoint security tools deployed to the system, world-open file shares, operating system misconfigurations. Further examples are described in table 510 at FIG. 5B of the embodiments. Accordingly, for example, the system 300 may apply a color to each node, and the color applied to a node may represent the risk of exposure based on threats relevant to the node and mitigating controls.

The arrows displayed in the risk-colored network graph 400 represent an observed direction of the data flow between nodes. The system 300 applies a color to each arrow based on an amount of the data flow. The system 300 may also display a respective label with each arrow (e.g., a numerical label, for example, the number 2.5 between node-96 and node-95, the number 1.0 between node-95 and node-26) based on the amount of the data flow between nodes. For simplicity, the node names and labels for all nodes and arrows are not shown, and it is to be understood that the names, colors, and numerical labels (e.g., numerical values) are not limited to the examples provided herein.

In the example illustrated at FIG. 4B, the system 300 may further display one or more notifications 405 (e.g., notification 405-a through notification 405-e) indicating information associated with the risk-colored network graph 400 and the corresponding network. Alternatively, the system 300 may refrain from displaying the notifications 405, as illustrated at FIG. 4A.

Examples are now described with reference to the risk-colored network graph 400 of FIGS. 4A and 4B.

According to the risk-colored network graph 400 generated by the system 300 (and in some aspects, using notification 405-a), the system 300 indicates that an asset corresponding to node-159 in the risk-colored network graph 400 shows no risk exposure (e.g., green). The asset is an instrumented asset and measured controls in place are operating effectively.

According to the risk-colored network graph 400 generated by the system 300 (and in some aspects, using notification 405-b), the system 300 indicates an asset corresponding to node-6 shows slightly elevated risk exposure (red). The system 300 determines and indicates that prioritized remediation is not recommended for node-6 due to a lack of outbound connectivity from the asset to other assets of the network.

According to the risk-colored network graph 400 generated by the system 300 (and in some aspects, using notification 405-c), the system 300 indicates that assets respectively corresponding to node-96 and node-131 are “high-value” assets. For example, the system 300 may deem the assets as “high-value” assets based on the amount of connectivity between the assets and other assets of the network.

According to the risk-colored network graph 400 generated by the system 300 (and in some aspects, using notification 405-d), the system 300 indicates an asset corresponding to node-100 shows neutral risk exposure (gray). In the example, the system 300 determines and indicates that there is no asset record match for the asset among assets associated with a target organization (i.e., lack of instrumentation).

According to the risk-colored network graph 400 generated by the system 300 (and in some aspects, using notification 405-e), the system 300 indicates an asset corresponding to node-26 shows elevated risk exposure (red). The system 300 determines and indicates that prioritized remediation is recommended due to inbound and outbound connections with respect to the asset and other assets of the network.

FIG. 5A illustrates an example of a risk scoring provided by the systems and techniques described herein in accordance with one or more embodiments of the present disclosure. The system 300 may implement the risk scoring using the risk scoring module 330 described with reference to FIGS. 3A and 3B.

The system 300 may generate a risk of exposure 500 (i.e., a risk score R(v)) for each of the nodes, where the risk of exposure 500=threat likelihood x control strength. That is, the system 300 may measure the exposure 500 at each node by factoring in quantified likelihood of cyber threats and efficacy of known controls (e.g., control actions) to mitigate applicable threats.

The threat likelihood may be calculated by the system 300 and may be a measure of the sampled likelihood of a specific threat vector based on historic knowledge. The control strength may be calculated by the system 300 and may be a measure of the efficacy of cyber control based on system-generated evidence of defects.

The system 300 may generate the risk of exposure 500 using the following equation:

$$R ( {v}_{i} ) = \frac{1}{m} {\sum }_{j = 1}^{m} {ω}_{i j} * ( 1 - {c}_{i} ( v ) ) * {t}_{j} ( v )$$

The risk score R(v) measures the risk of exposure of a node v and is calculated based on estimated likelihood of a set of threats 0≤tⱼ(v)≤1 applicable to v and threat mitigating controls measured by control indicators cᵢ(v).

The system 300 may further provide risk information 505 associated with the risk of exposure 500. For example, the risk information 505 may include an indication of a risk scenario, threats, mitigations, and control indicators as determined by the system 300. The system 300 may provide risk modeling of risks, and the risk modeling may include the risk information 505.

In determining the exposure 500, the system 300 may apply a function φ(v)=[c₁(v), c₂(v), c₃(v), . . . , cₙ(v)]∈Rⁿ which maps each node into an n-dimensional feature space indexed by control indicator functions 0≤cᵢ(v)≤1, whereas cᵢ(v) defines the control strength of the i-th control of node v.

Non-limiting examples of the control indicators provided in the risk information 505 are outlined at table 510 illustrated at FIG. 5B.

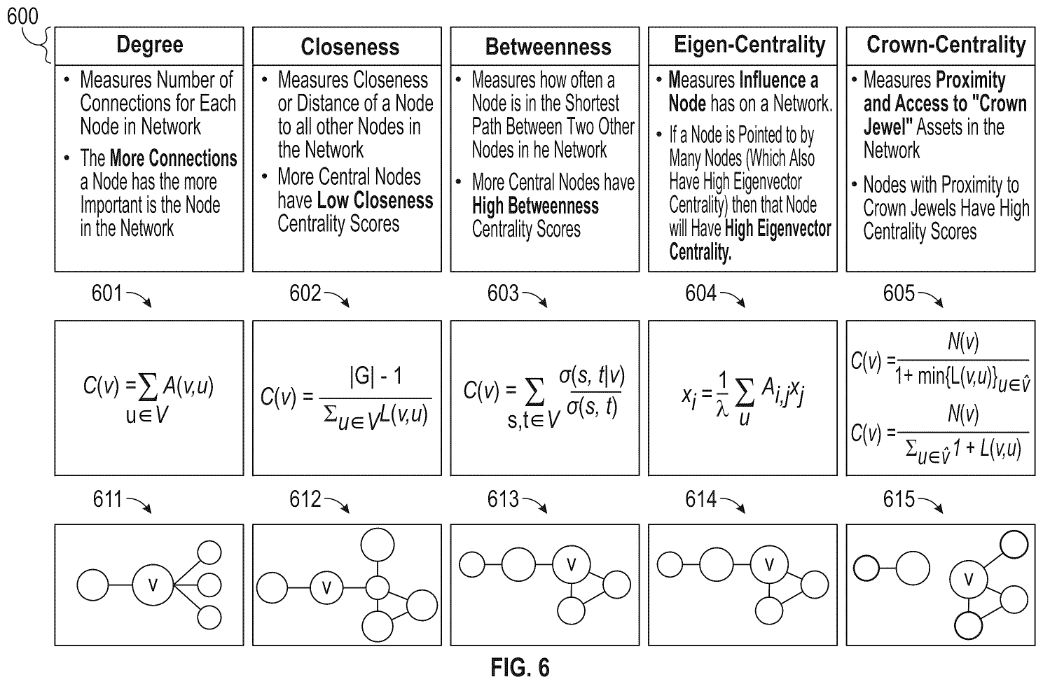

FIG. 6 illustrates an example of centrality measures 600 used by the system 300 in determining asset importance, in accordance with one or more embodiments of the present disclosure. The system 300 may generate the centrality measures 600 through calculations performed by the network mapping module 321 described with reference to FIGS. 3A and 3B.

The system 300 may determine asset importance for each of the assets of a network using the concept of centrality (i.e., using the centrality measures 600). The asset importance for each asset may be a quantification of the level of importance and influence of a specific asset (as represented by a node in the risk-colored network graph 400) in the network.

The centrality measures 600 may include degree, closeness, betweenness, eigen-centrality, or crown-centrality, determined using equations indicated at FIG. 6 and further described herein.

The degree is a measure of the number of connections for each node in network. The system 300 may determine the degree or importance of a node based on the number of connections the node has to other nodes in the network. For example, the more connections a node has, the more important is the node in the network.

The system 300 may calculate the degree of a node to determine importance based on the principle of network centrality as defined in equation 601 provided in FIG. 6 and reproduced below. Degree centrality C(v) of a node v measures how many inbound, outbound, or total direct connections a node has in a network. The variable A defines an adjacency matrix that defines 1 for any two connected nodes in a graph and 0 otherwise.

$$C ( v ) = {\sum }_{u ∈ V} A ( v , u )$$

An example graph 611 showing respective degrees of nodes as calculated using equation 601 is illustrated at FIG. 6.

The closeness (also referred to herein as a closeness centrality score) is a measure of closeness or distance of a node to all other nodes in the network. For example, nodes which are more central compared to other nodes may have low closeness centrality scores.

The system 300 may calculate the closeness for a node based on the equation 602 provided in FIG. 6 and reproduced below. The variable G refers to a graph with |G| nodes. The variable L(v,u) denotes the length of the shortest path between node v and node u.

$$C ( v ) = \frac{\vert G \vert - 1}{{\sum }_{u ∈ V} L ( v , u )}$$

An example graph 612 showing respective closeness values of nodes as calculated using equation 602 is illustrated at FIG. 6.

The betweenness (also referred to herein as a high betweenness centrality score) is a measure of how often a node is in the shortest path between two other nodes in the network. For example, nodes which are more central compared to other nodes may have high betweenness centrality scores.

The system 300 may calculate the betweenness for a node based on the equation 603 provided in FIG. 6 and reproduced below. σ(s,t) refers to the total number of shortest paths from node s to node t. σ(s, t|v) refers to number of those shortest paths that pass through node v.

$$C ( v ) = {\sum }_{s , t ∈ V} \frac{σ ( s , t \vert v )}{σ ( s , t )}$$

An example graph 613 showing respective betweenness values of nodes as calculated using equation 603 is illustrated at FIG. 6.

The eigen-centrality (also referred to herein as eigenvector centrality) measures the influence a node has on a network. Eigenvector centrality is computed by finding the eigenvector corresponding to the largest eigenvalue (called the principal eigenvector) of the adjacency matrix. Eigenvector centrality measures a node's influence in a network by considering the importance of the connections to the node, not just the number of connections. The system 300 may determine the eigenvector centrality of a node based on the number of other nodes which point to the node, and further, whether the other nodes have relatively high eigenvector centrality. For example, if a node is pointed to by many nodes (which also have high eigenvector centrality), the system 300 may determine or consider the node as having high eigenvector centrality.

The system 300 may calculate the eigen-centrality for a node based on the equation 604 provided in FIG. 6 and reproduced below, whereas Aᵢⱼ denotes an adjacency matrix indicating 1 for any two nodes that are connected and 0 otherwise and λ denotes the largest eigenvalue of A and xᵢ refers to the centrality of node i.

$${x}_{i} = \frac{1}{λ} {\sum }_{i = 1}^{n} {A}_{ij} {x}_{j}$$

An example graph 614 showing respective eigen-centrality values of nodes as calculated using equation 604 is illustrated at FIG. 6.

The crown-centrality measures proximity and access to “crown jewel” assets (e.g., assets determined by the system 300 as having relatively high importance) in the network. The system 300 may assign high centrality scores to nodes within a target proximity to such “crown jewel” assets.

An example graph 615 showing respective crown-centrality values of nodes as calculated using equation 605 is illustrated at FIG. 6. In graph 615, crown jewels are indicated with thick lines. The closer a node v is to one or multiple crown jewels (, the higher it's the score for the node v.

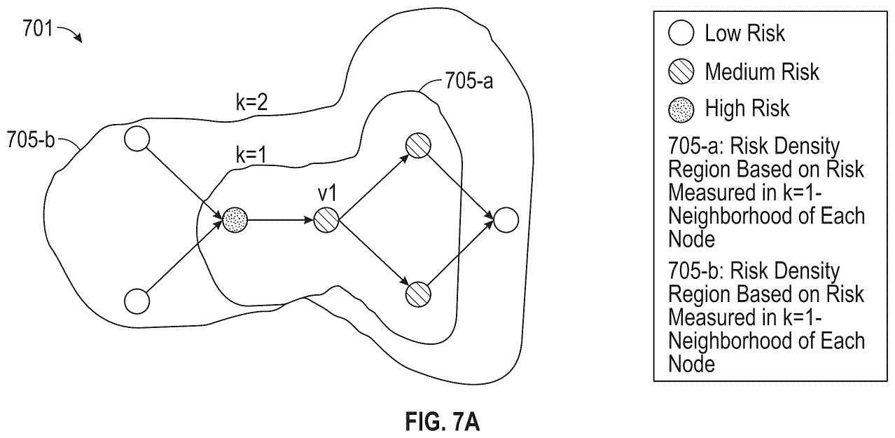

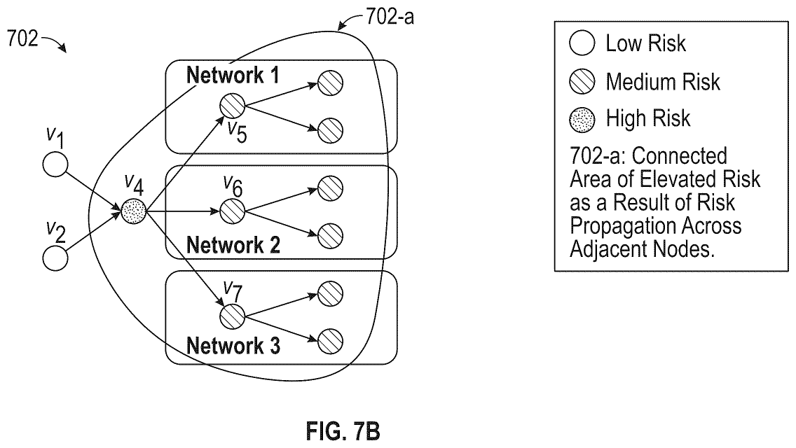

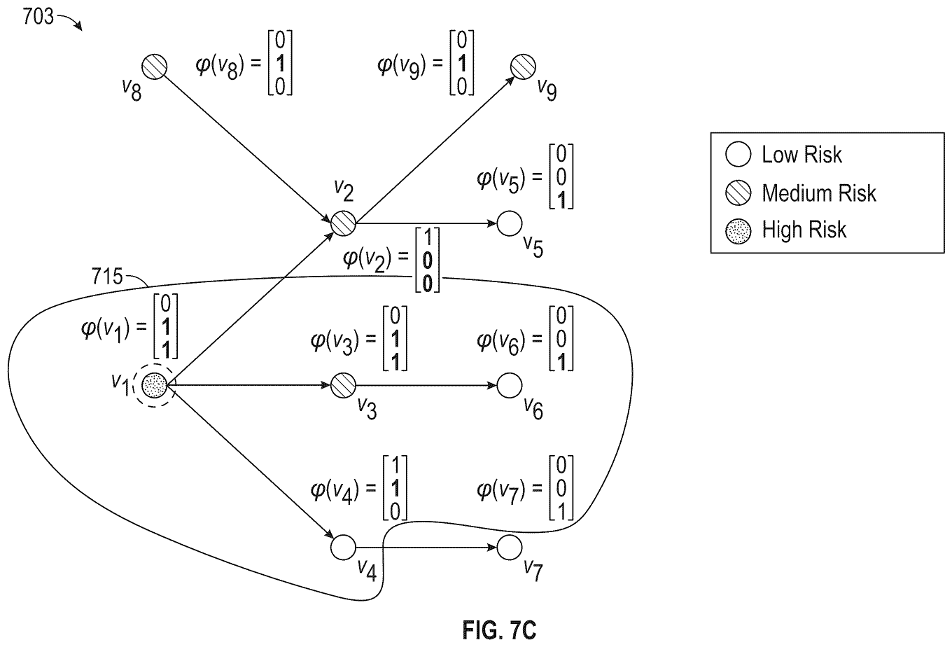

FIG. 7A illustrates aspects of risk density as calculated using the systems and techniques described herein. FIGS. 7B and 7C illustrate aspects of risk propagation as calculated using the systems and techniques described herein.

In accordance with one or more embodiments of the present disclosure, additionally or alternative to measuring individual risk on nodes in a network as described herein, the system 300 may determine and apply risk density, risk propagation, or both to account for areas of systemic risk in a network.

With reference to FIG. 7A and the example graph 701, risk density measures the concentration of cyber risk in the neighborhood of a compute node in a connected graph. In physics, density measures distribution of a quantity per unit of space (e.g., length, area, or volume). As to a risk-colored network graph 400 in accordance with one or more embodiments of the present disclosure, the risk density measures concentration of risk per unit of space (e.g., network range, adjacent neighbors, cliques) in the risk-colored network graph 400.

The equation N^{k}(v)={u∈V|d(u,v)≤k} denotes the closed k-th neighborhood of a node v including all nodes directly or indirectly connected to the node v within a distance k to the node v. With reference to FIG. 7A, neighborhood 705-a is a closed 1st neighborhood of node v1, and neighborhood 705-a includes all nodes directly or indirectly connected to node v1 within a distance of k=1. Neighborhood 705-b is a closed 2nd neighborhood of node v1, and neighborhood 705-b includes all nodes directly or indirectly connected to node V1 within a distance of k=2.

Risk density \hat{R}(v) can be defined by the following equation:

$$\hat{R} ( v ) = \frac{1}{\vert {N}^{k} ( v ) \vert} {\sum }_{u ∈ {N}^{k} ( ν )} {w}_{u} * R ( u ) \hat{R} ( v ) = \frac{1}{\vert {N}^{k} ( v ) \vert} {\sum }_{u ∈ {N}^{k} ( ν )} {w}_{u} * R ( u ) ,$$

wᵤ denotes the risk contribution of a node u in the k-th neighborhood of node v to the total risk density of node v. The weight of a node can decay linearly or exponentially as a function of distance of node u to node v.

Exponential decay can be defined as follows:

$${w}_{u} = {α}^{d ( u , v )} with 0 < α < 1$$

Linear decay can be defined as follows:

$${w}_{u} = max ( 0 , 1 - \frac{d ( u , v )}{k} )$$

Alternatively, embodiments of the present disclosure may include reformulating risk density to use an indicator function I to account for risk exceeding certain risk levels. Using this reformulated calculation for risk density, the risk density of a node will be high for cases in which there is a concentration of nodes with high risk in the vicinity of the node, as shown by the following equation:

$$\hat{R} ( v ) = \frac{1}{\vert {N}^{k} ( v ) \vert} {\sum }_{u ∈ {N}^{k} ( ν )} I ( R ( u ) \geq t )$$

Accordingly, for example, the systems and techniques may utilize risk density for identifying areas of concentration of elevated cyber risk in a network.

With reference to FIG. 7B and the example risk-colored network graph 702, risk propagation measures the degree of risk spreading in the risk-colored network graph 702. Risk can be propagated through hubs (i.e., nodes with high centrality) or bridges (i.e., direct tie between nodes that would otherwise be in disconnected components of the graph). For example, in considering lateral movement of wormable malware in a network, determining risk propagation may include identifying nodes (e.g., node V4 in FIG. 7B) in the network that demonstrate a high degree of centrality (e.g., hubs, bridges) and allow the propagation of risk because of similar control deficiencies to an adjacent node (e.g., node V5, node V6, or node V7 in FIG. 7C) along a particular network path.

With reference to FIG. 7C and the example graph 703, the systems and techniques described herein may include defining risk propagation areas (e.g., risk propagation area 715) by connected nodes with similar control deficiencies, despite some of the nodes having low individual risk scores. In this example, addressing control deficiencies on node V1 would have a risk reduction effect downstream on nodes in the direct neighborhood (e.g., node V3, node V6, node V4) and nodes in the indirect neighborhood (e.g., node V2, node V9, node V5). The higher the centrality and the risk propagation value of a node, the higher the impact-to-asset ratio. Accordingly, for example, through risk propagation, the systems and techniques described herein may identify a set of connected nodes (e.g., node V1, node V3, node V6, node V4) in a graph having different individual risk values but a risk propagation potential. For example, the systems and techniques described herein may identify that the set of connected nodes have a risk propagation potential due to similar control deficiencies across neighboring nodes which may allow threats to further propagation through the network.

In an example, the systems and techniques may determine a risk propagation value for a node v using the following equation:

$$\hat{R} ( v ) = {\sum }_{u ∈ {N}^{+} ( v )} {K}_{linear} ( u , v ) * R ( u )$$

In the equation, N⁺(v) denotes the neighborhood of node v, in which the neighborhood includes all nodes that can be reached from node v. Kₗᵢₙₑₐᵣ(u, v) denotes the normalized linear kernel (i.e., inner product) between nodes u and node v. In some aspects, two adjacent nodes (i.e., nodes directly connected to one another without another node in between) with different control deficiencies may result in a relatively small kernel value and therefore result in a lower risk contribution to the overall risk propagation value of node v.

On the other hand, a high kernel value signals a higher probability for threat propagation along a path of nodes in the network. Therefore, the techniques described herein may consider the risk contribution to the overall risk propagation value of node v by a node adjacent to the node v as being higher. The techniques described herein may include prioritizing a node v with high risk propagation value (e.g., node V1 in FIG. 7C) as a node for remediation, as the node v influences threat propagation potential across nodes that can be directly or indirectly reached (e.g., node V2, node V9, node V5, node V2, node V6, node V4, node V7) from the node v.

Example aspects of risk analysis implemented by the system 300 using the risk analysis module 345 is described herein. In an example, the system 300 may prioritize remediation activities based on the extent of cyber risk on the asset and the importance of the asset in the network. In an example, the system 300 may prioritize high cyber risk on important assets over high cyber risk of relatively less important assets, thereby providing an efficient and risk-focused prioritization.

The system 300 may measure the importance I(v) of an asset based on the influence of the asset on its environment. In some aspects, the system 300 may measure the influence of an asset using centrality measures 600 described with reference to FIG. 6. Crown centrality is a centrality measure supported by the present disclosure which bridges the gap between the concept of distance-based asset importance and business context. Crown centrality measures proximity and access to “crown jewel” computing nodes in a computer network. The system 300 may calculate and assign relatively high centrality scores for nodes with proximity to “crown jewels.”

The system 300 may measure the importance C(v) of an asset based on the following equation focusing on the distance to the crown jewel assets closest to node v:

$$I ( v ) = \frac{N ( v )}{1 + min {\{ L ( v , u ) \}}_{u ∈ \hat{v}}}$$

$$C ( v ) = \frac{N ( v )}{1 + min {\{ L ( v , u ) \}}_{u ∈ \hat{v}}}$$

Alternatively, the system 300 may measure the importance C(v) of an asset based on the following equation focusing on the average distance to all crown jewel assets that can be reached from node v:

$$C ( v ) = \frac{N ( v )}{{\sum }_{u ∈ \hat{v}} 1 + L ( v , u )}$$

In the equation, N(v) denotes the number of neighbors of node v, and L(v,u) denotes the length of the shortest path from node v to a crown jewel asset u∈\hat{V}. A “crown jewel” asset refers to an asset which is the most valuable, the most strategically important, or most high performing (e.g., high performance) as owned by a company or organization.

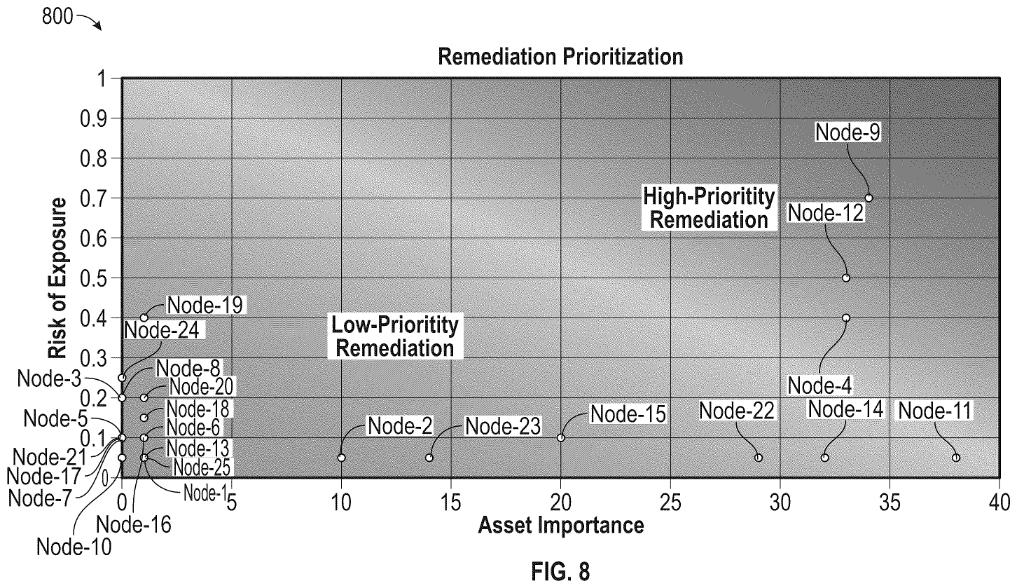

FIG. 8 illustrates an example graph 800 generated by the system 300 in accordance with one or more embodiments of the present disclosure. The graph 800 may be implemented using different colors, patterns, symbols or the like to indicate remediation prioritization respective to the nodes included in a risk-colored network graph (e.g., risk-colored network graph 400) described herein.

Nodes may be positioned in the graph 800 according to respective risk of exposure and asset importance. For example, in the graph 800, node-10 is associated with low-priority remediation, and node-9 is associated with high-priority remediation. Through the techniques described herein and the graph 800, remediation can be prioritized based on risk of exposure and asset importance, taking cyber risk more holistically into account.

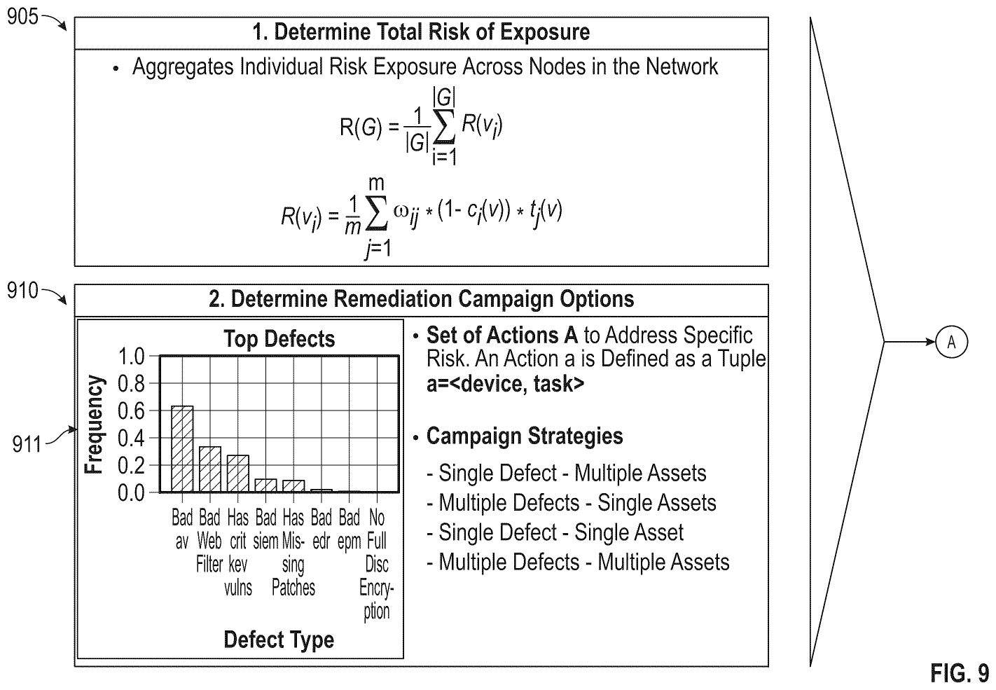

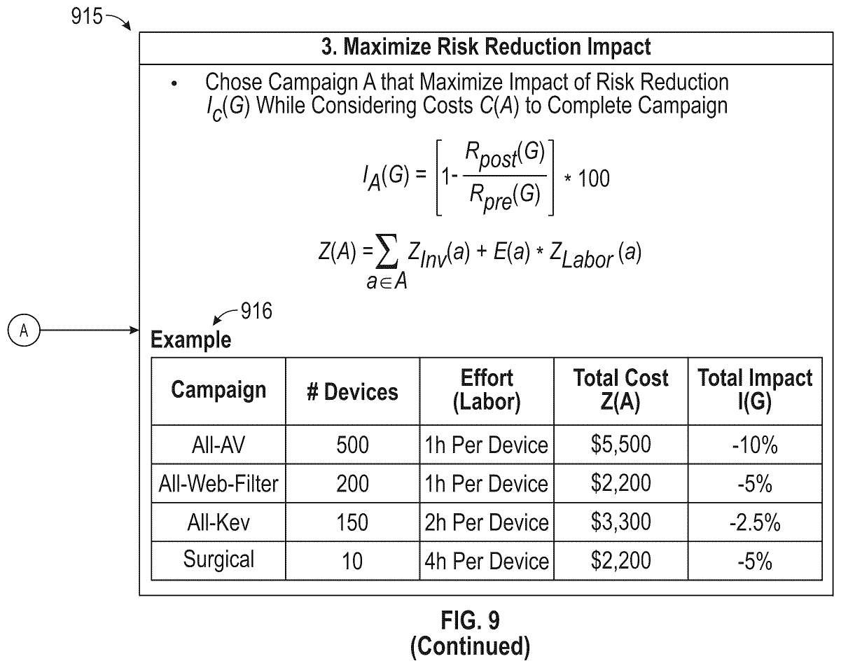

FIG. 9 illustrates an example flowchart of a method 900 in accordance with one or more embodiments of the present disclosure. The method 900 may be implemented by the example aspects of the system 300 described herein. The method 900 provides features of how to choose what to fix and how to measure the impact of the fix with respect to a network.

At block 905, the method 900 includes determining a total risk of exposure across nodes (e.g., assets) in the network. Determining the total risk of exposure includes aggregating individual risk exposure across nodes in the network represented by a graph G, using the following equations:

$$R ( G ) = \frac{1}{\vert G \vert} {\sum }_{\dot{ι} = 1}^{\vert G \vert} R ( {v}_{i} )$$

$$R ( {v}_{i} ) = \frac{1}{m} {\sum }_{j = 1}^{m} {ω}_{i j} * ( 1 - {c}_{i} ( v ) ) * {t}_{j} ( v )$$

(as described with reference to risk of exposure 500 at FIG. 5A)

At block 910, the method 900 includes determining remediation campaign options. For example, the method 900 includes determining a set of actions ‘A’ to address a specific risk. An action ‘a’ is defined as a tuple, where a=<device, task>.

Example campaign strategies include: single defect-multiple assets; multiple defects-single assets; single defect-single asset; multiple defects-multiple assets.

In some aspects, at block 910, the method 900 includes determining and listing top defects according to frequency and defect type, as illustrated in the example graph 911.

At block 915, the method 900 includes maximizing risk reduction impact. For example, the method 900 includes choosing a campaign ‘A’ that maximize impact of risk reduction I_{A}(G) while considering costs Z(A) to complete the campaign ‘A’, based on the following equations, whereas Z_{Inv}(a) denotes the total investment costs required to complete action ‘a’, Z_{Labor}(a) refers to the labor cost to complete action ‘a’ (e.g. cost per hour) and E(a) describes the per device effort (e.g. hours) to complete an action ‘a’.

$${I}_{A} ( G ) = [ 1 - \frac{{R}_{post} ( G )}{{R}_{pre} ( G )} ] * 100$$

$$Z ( A ) = {\sum }_{a ∈ A} {Z}_{Inv} ( a ) + E ( a ) * {Z}_{Labor} ( a )$$

The example table 916 illustrates example campaigns along with respective number of devices, effort E, total cost Z(A) and total impact I(G).

As has been described herein, the cyber risk remediation provided by the systems and techniques described herein include methods of determining individual risk, risk density, and risk propagation and applying the methods in guiding surgical risk reduction. The techniques described herein may aim for finding the assets that are most impactful to address and are related to the true risk of a network. The different methods measure risk differently taking different aspects into consideration.

Individual risk may be considered as a relatively standard approach among the different methods. A method described herein of determining individual risk may omit accounting for risk in a node's environment, but may be meaningful due to consideration of both risk of exposure and asset impact (centrality of a node) during prioritization. The method contextualizes risk with network and data flow aspects, which may provide improved precision.

Risk density of a node is represented by the amount of elevated risk in the closed k-neighborhood of the node. A method described herein of determining risk density across each node in a graph includes generating a risk coloring that is different from the risk coloring using individual risk. By applying a defined threshold according to the risk density values, the method includes defining a boundary around a set of connected nodes in a network that may be prioritized all together in a surgical campaign. In contrast to individual risk, the method of determining risk density includes selecting a group of connected assets to address—not just individual assets. Combined with asset importance, the method is capable of finding regions of connected nodes with at least one node in the set having high centrality.

Risk propagation takes dynamic aspects of threat propagation potential into account based on similarity in control posture between adjacent nodes. As an example, a potential threat (e.g. wormable malware or hacker moving laterally across the network) can move across paths ins network as long as adjacent nodes on a path have identical or similar control defects. Examples of such adjacent nodes having identical or similar control defects include multiple connected nodes with a specific exploitable vulnerability, multiple connected nodes with file shares world open, or multiple connected nodes with malfunctioning anti-malware.

The higher the risk propagation value of a node, the higher the impact of the overall risk reduction in the environment of the node. Expressed another way, fixing the nodes with highest risk propagation value may create a choke points for preventing threats from further propagating through the network. Accordingly, for example, creating such a choke point at a node with a relatively high risk propagation value may result in a positive downstream risk reduction impact for all defective nodes that can be directly or indirectly reached from the node, without touching any of the downstream defective nodes. Focusing on assets with high risk propagation values may save organizational resources and time, which may enable an increase in both efficiency of risk reduction operations and workforce productivity, as other tasks/priorities can instead be focused on.

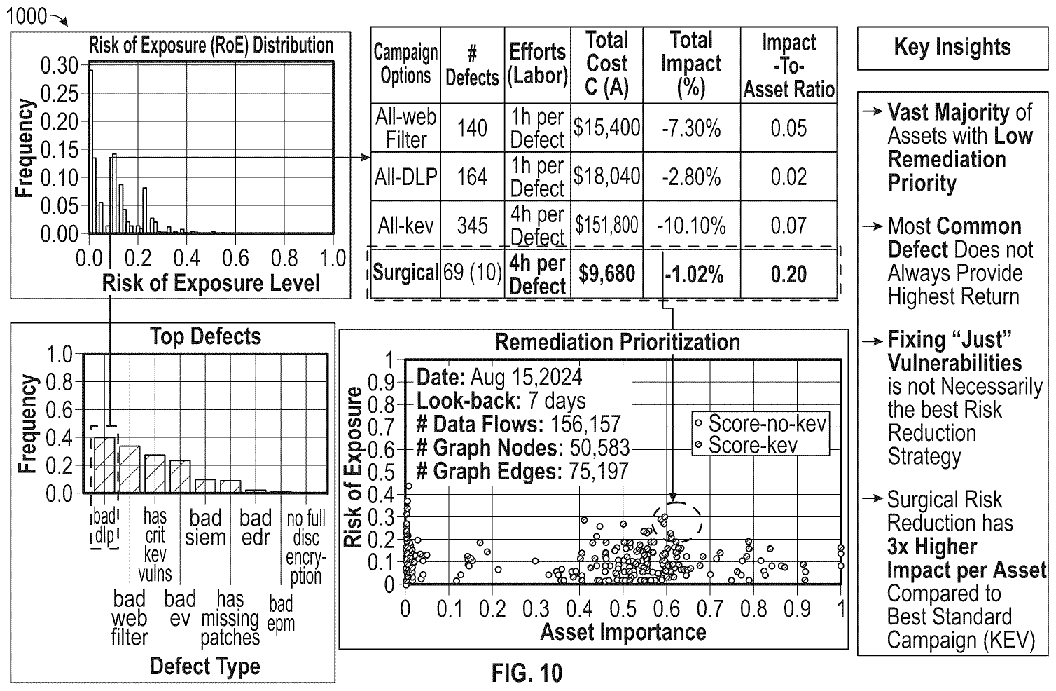

FIG. 10 illustrates experimental results 1000 achieved using the systems and techniques described herein (i.e., surgical campaign option) in accordance with one or more embodiments of the present disclosure compared to other approaches. The experimental results 1000 indicate that the surgical risk reduction provided by the systems and techniques described herein is more effective than broad defect remediation with less effort.

The experimental results 1000 include risk of exposure (RoE) distribution 1005 according to frequency and risk of exposure level, top defects 1010 according to frequency and defect type, a table 1015 of details associated with different campaign options, a graph 1020 of remediation prioritization according to risk of exposure and asset importance, and key insights information 1025.

In the experimental results 1000, the graph 1020 indicates ‘Date: Aug. 15, 2024’, ‘Look-back: 7 days’, ‘#Data Flows: 156,157’, ‘#Graph Nodes: 50,583’, and ‘#Graph Edges: 75,197’ associated with implementing remediation prioritization in accordance with one or more embodiments of the present disclosure.

According to the experimental results 1000, for a case in which a vast majority of assets have a low remediation priority, the following conclusions may be made: the most common defect does not always provide highest return, fixing “just” software vulnerabilities is not necessarily the best risk reduction strategy, and surgical risk reduction according to the techniques described herein has 3× higher impact per asset compared to the best standard campaign (i.e., Known Exploited Vulnerability (KEV) remediation)

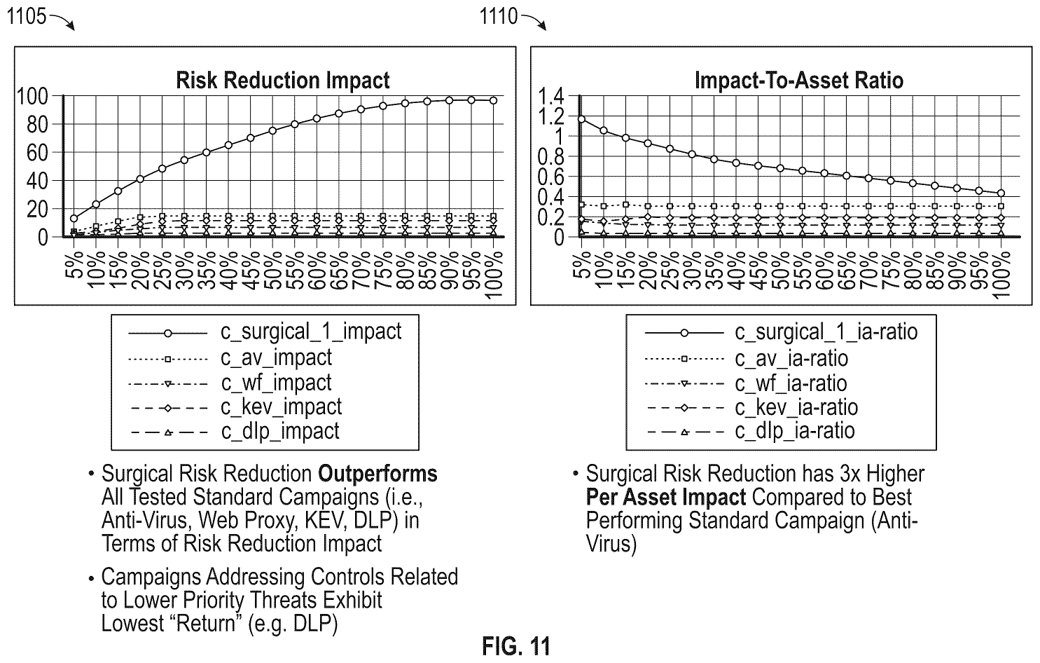

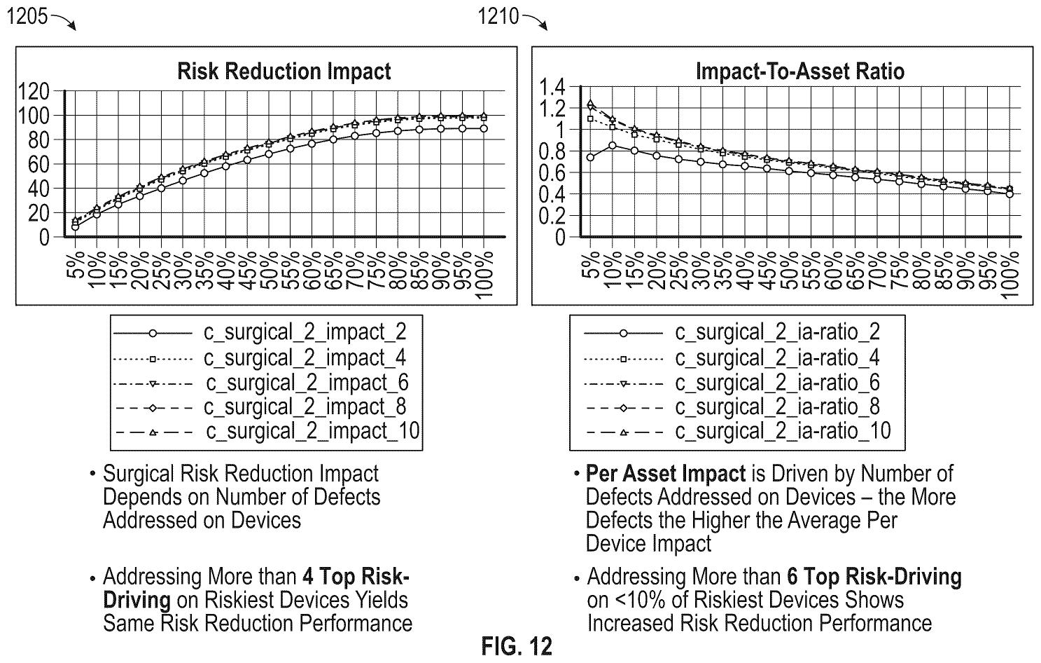

FIGS. 11 and 12 illustrate results determined through the comparison of the techniques of surgical risk reduction (based on individual asset risk) as supported by the present disclosure against some conventional risk reduction strategies.

FIG. 11 illustrates a graph 1105 (risk reduction impact; surgical remediation effectiveness) and a graph 1110 (impact-to-asset ratio; per asset risk reduction impact) comparing results achieved using risk-based surgical remediation and risk reduction impact supported by the present disclosure against results achieved using some other techniques or campaigns.

Referring to graph 1105, surgical risk reduction provided using the techniques described herein outperforms all tested standard campaigns (i.e., Anti-Virus, Web Proxy, KEV, DLP) in terms of risk reduction impact. Campaigns addressing controls related to lower priority threats exhibit lowest “return” (e.g., DLP).

Referring to graph 1110, surgical risk reduction provided using the techniques described herein has a 3x higher per asset impact compared to a high performing standard campaign (e.g., Anti-Virus).

FIG. 12 illustrates a graph 1205 (risk reduction impact) and a graph 1210 (impact-to-asset ratio) comparing results achieved using risk-based surgical remediation and risk reduction impact supported by the present disclosure against results achieved using some other techniques or campaigns. The graph 1205 and the graph 1210 illustrate the impact of defects on risk reduction.

Referring to graph 1205, surgical risk reduction impact may depend on the number of defects addressed on devices. Addressing more than the four top risk-driving defects on the riskiest devices (i.e., devices having relatively the highest risk) may yield the same risk reduction performance.

Referring to graph 1210, the per asset impact is driven by number of defects addressed on devices, such that an increase in the number of defects results in a higher average impact per device. Addressing more than the six top risk-driving on greater than 10% of the riskiest devices shows increased risk reduction performance.

In accordance with one or more embodiments of the present disclosure, the techniques described herein may include a return on investment/impact calculation. The return on investment/impact calculation may be implemented by the system 300 described herein. The return on investment/impact calculation may refer to an asset impact described herein.

Asset impact is defined as impact of risk reduction per asset, which is total risk reduction (e.g., from fixing control issues) divided by the number of assets impacted or touched. Total risk reduction can be defined as the difference between the total risk R(v) across all nodes v in V in a network graph before and after applying a set of remediation actions A on a subset of devices.

In an example observation, in comparing larger standard remediation campaigns (e.g. fix anti-virus on 1000 systems with known anti-virus defects) to a surgical campaign (i.e. fix ALL defects on a select, small set of assets), the absolute amount of risk reduction through a standard campaign may be relatively higher than the risk reduction of a surgical campaign due to the shear difference of both populations. However, though a standard campaign may quantitatively demonstrate significant risk reduction, the probability of defects being fixed meaningfully is relatively low, meaning that the standard campaign wastes significant organizational resources to go after issues that might not matter in the big picture with respect to a network.

In another example observation, as seen by dividing the total risk reduction (%) by the number of affected assets, surgical risk reduction is significantly more impactful compared to standard risk reduction, meaning that surgical risk reduction addresses risk with respect to devices that actually matter for an organization.

The example observations apply for individual risk, risk density, and risk propagation described herein.

Example use cases to which the techniques described herein may be applied are described. The example use cases are directed to effective support fusion-oriented cyber defense capabilities, which may be implemented by leveraging risk-colored network graphs using the techniques described herein. The example use cases include surgical risk response, network breach analysis, targeted penetration testing, network anomaly detection, resiliency analysis, and targeted threat hunting.

Surgical risk response: What are areas of high risk and how to efficiently and effectively mitigate risk across the network?

Network breach analysis: What are probable attack paths and what is the probability of high-value assets being compromised?

Targeted penetration testing: What are effective penetration testing approaches to compromise high-value assets in the networks?

Network anomaly detection: What assets are regularly communicating with each other at what frequency and over which network protocols to detect deviations from learned baselines that allow to detect unusual network communication behavior?

Resiliency analysis: What are security architectural weak points in the network and what systems are critical to maintain connectivity between network segments?

Targeted threat hunting: Which other devices are connected to risk-exposed devices and do they show indications of compromise?

In accordance with one or more embodiments of the present disclosure, the systems and techniques described herein provide a holistic methodology which prioritizes defect remediation across different assurance domains. The systems and techniques described herein provide effective risk contextualization and surgical risk reduction. The systems and techniques described herein provide a quantifiable threat profile for nodes and associated risks, and such threat profile may precisely guide risk remediation priorities. Surgical risk reduction has an increased effectiveness with less effort compared to broad defect remediation, and the techniques described herein for surgical risk reduction support focusing on risk that matters most to an organization.

FIG. 13 illustrates an example method 1300 supportive of risk modeling in accordance with one or more embodiments of the present disclosure. The method 1300 may be implemented by the system 300 described herein.

At block 1305, the method 1300 includes generating a threat model 1306. At block 1310, the method 1300 includes generating a threat-control mapping 1311. At block 1315, the method 1300 includes generating a control-risk indicator mapping 1316.

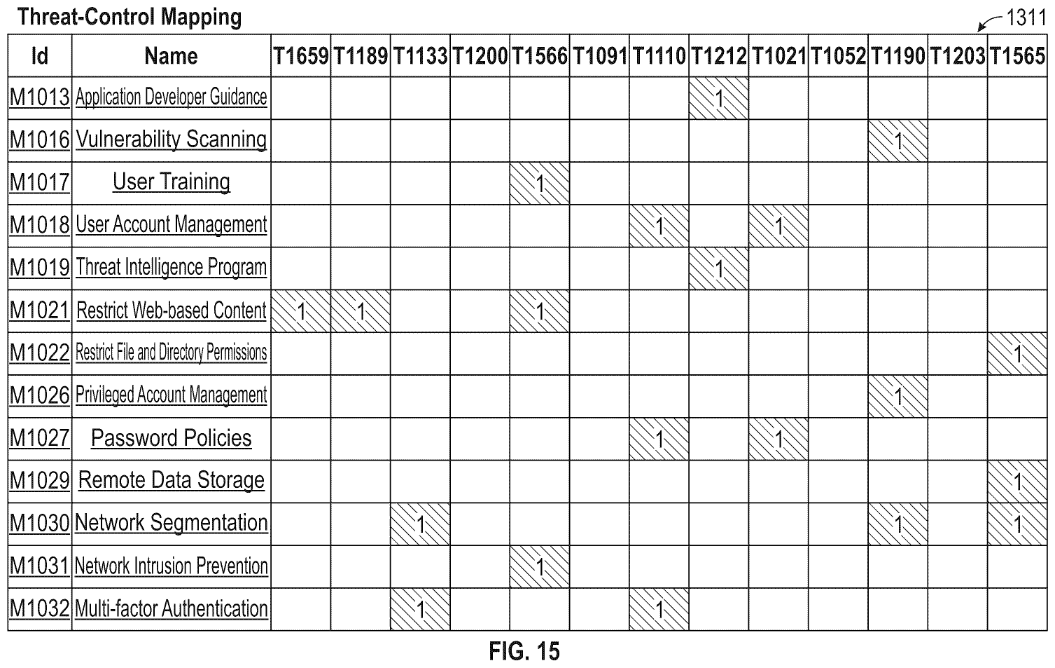

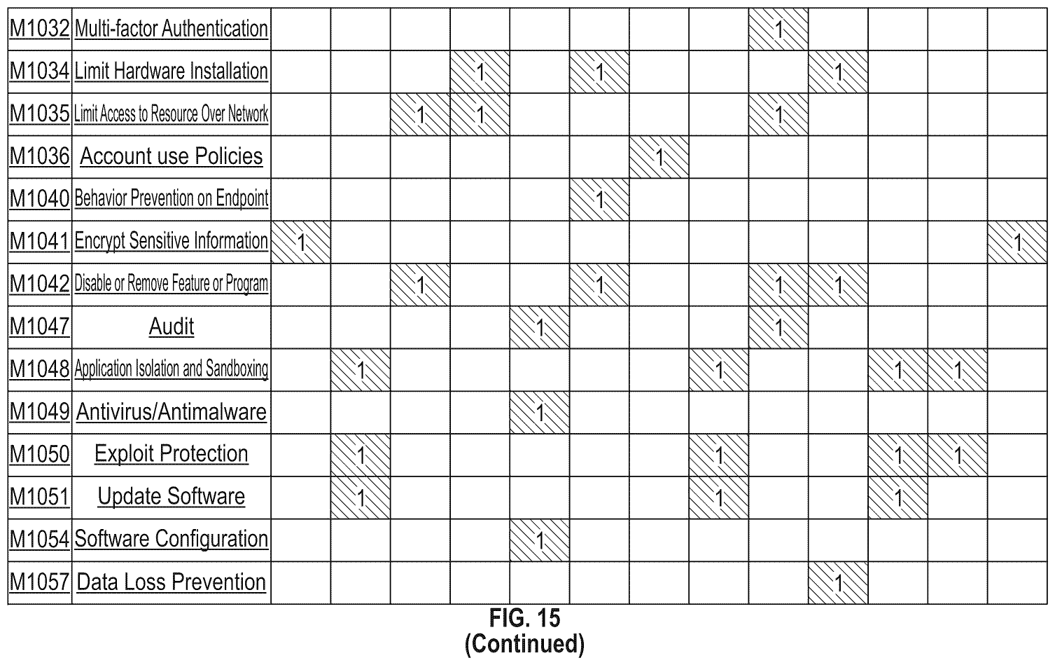

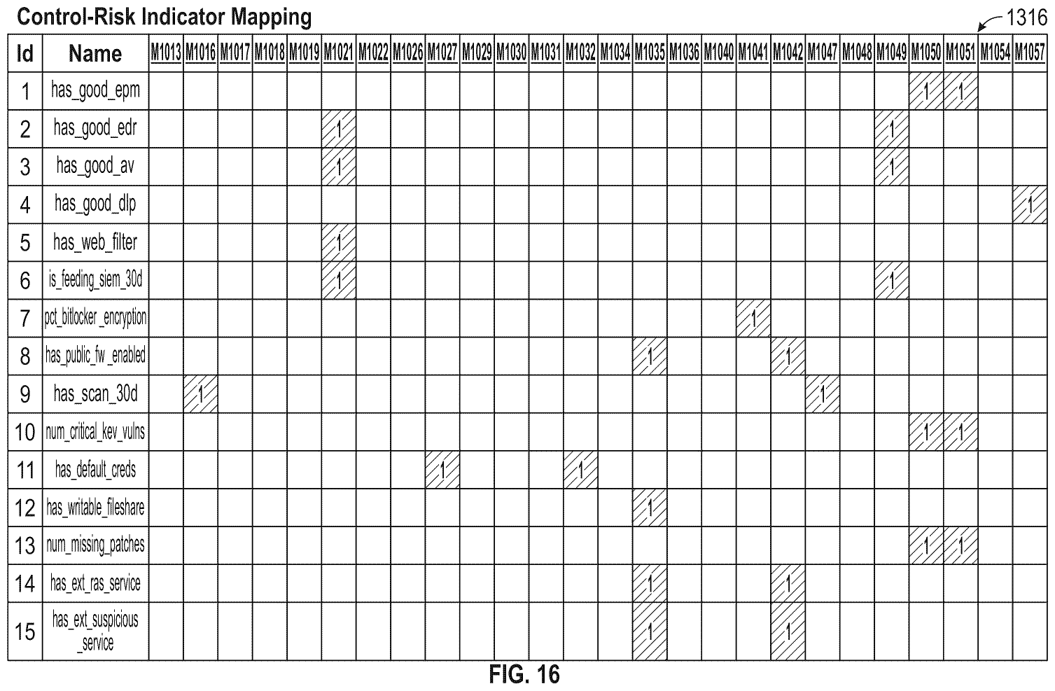

FIGS. 14 through 16 illustrate example tables of information included in the threat model 1306, the threat-control mapping 1311, and the control-risk indicator mapping 1316.

The threat model 1306 includes a definition of cyber threat vectors (e.g. based on a knowledgebase of adversary tactics and techniques according to real-world observations). The threat model 1306 may include an estimation of threat likelihoods for cyber threat vectors based on historic data from threat intelligence feeds.

The threat-control mapping 1311 (also referred to herein as a threat control matrix) includes a definition of mitigations (e.g. based on a knowledgebase of adversary tactics and techniques according to real-world observations) and mapping against cyber threat vectors. The threat-control mapping 1311 may include a definition of impact of mitigation to counteract cyber threat vector(s).

The threat control mapping 1311 maps normalized threats to applicable mitigating controls. For example, a single threat can have multiple controls to counteract the threat exposure (e.g., T=“external-facing exploitation”, C={“Patching”, “Limit inbound traffic”, etc.,}). Moreover, a single control can contribute to the mitigation of multiple different threats. In some aspects, the higher the likelihood of a particular threat and the lower the overall measured control effectiveness across all controls applicable to the threat, the higher the risk.

The control-risk indicator mapping 1316 includes a definition of risk indicators (candidate risk indicators) and mapping to mitigations. The control-risk indicator mapping 1316 includes an estimation of risk indicator values based on data collection and aggregation as provided by a data collection service.

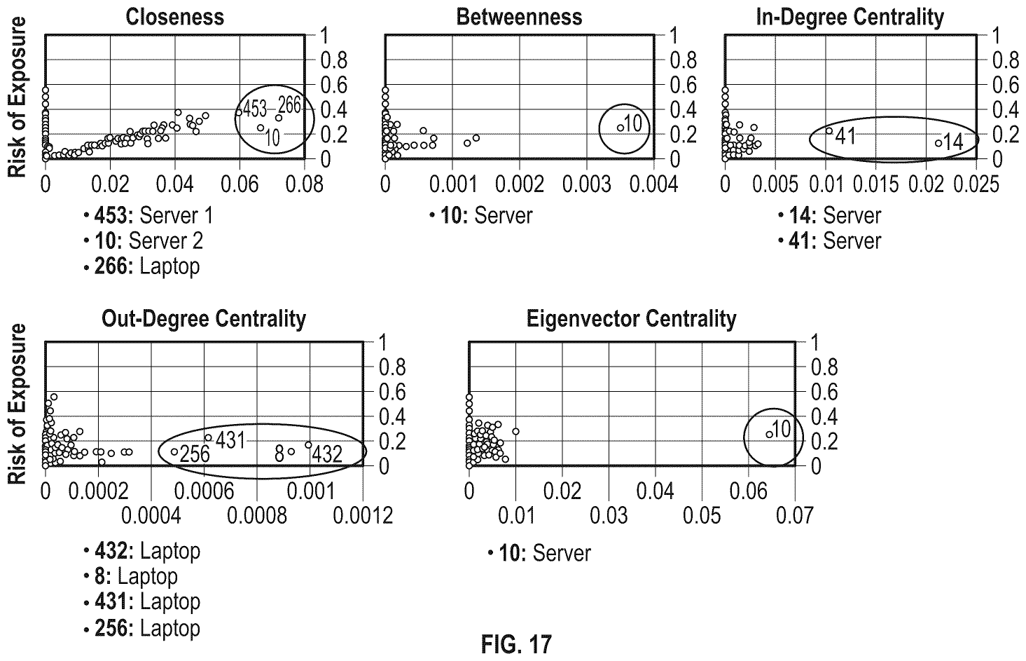

FIG. 17 illustrates examples of prioritization strategies and centrality measures (i.e., closeness, betweenness, in-degree centrality, out-degree centrality, eigenvector centrality) based on which asset importance can be determined in accordance with one or more embodiments of the present disclosure. With reference to FIG. 17, the vast majority of assets are low risk and low importance. Outliers are differing based on the centrality measure used to determine asset importance. For simplicity, all node names are not illustrated in FIG. 17.

As has been described herein, the systems and techniques supported by the present disclosure provide benefits through surgical risk reduction. Surgical risk reduction improves return on investment of a vulnerability management program for large organizations by continuously maximizing cyber risk reduction impact across the network while minimizing the amount of effort applied for addressing such risk. The techniques described herein of cyber risk remediation through surgical risk reduction have proven to outperform non-risk-based remediation campaigns, and the techniques described herein exhibit an impact per asset that is 3× higher in average than the best performing non-risk-based remediation campaign.

An organization may have a finite set of resources and priorities for risk reduction operations, and surgical risk reduction in accordance with one or more embodiments of the present disclosure may provide effective, targeted, and efficient optimization of workloads and may accelerate progress towards strategic objectives set by the organization.

The techniques described herein may be applied to vulnerability management programs. Performing surgical cyber risk reduction described herein significantly improves the return on investments of an enterprise vulnerability management program by allowing the organization to focus on risk reduction where it truly matters, instead of allocating a plethora of resources and time to fix issues on irrelevant compute devices. By leveraging asset criticality and through better understanding of the importance of an asset, remediation activities can be prioritized as outlined herein. The techniques described herein include prioritizing assets with high asset importance and high cyber risk score over assets with lower asset importance (e.g. edge devices without links or criticality) and lower cyber risk score.

Large organizations may oftentimes be hesitant to automate risk response due to lack of knowledge about an asset and the relevance of the asset in the context of business critical or revenue critical business processes. Therefore, the invention uses asset and network environment information to propose automated risk response based on the change risk score of each compute device in the network. The techniques described herein may include executing surgical risk reduction in a safe way for compute devices with low change risk and high cyber risk score, whereas compute devices with high change risk score and high cyber risk score follow the organization's change management process.

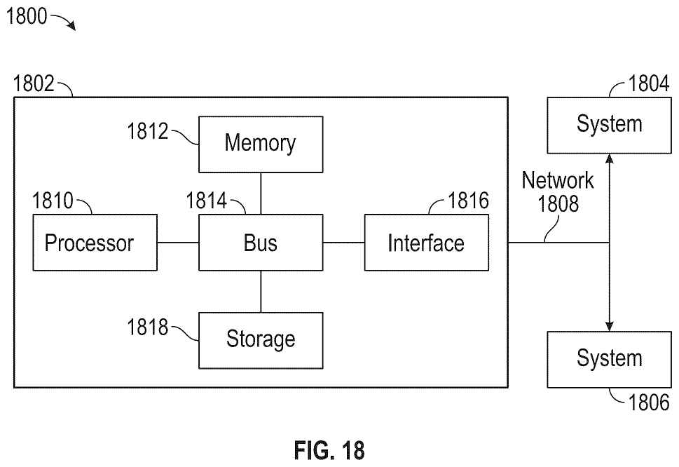

FIG. 18 is a block diagram of a distributed computer system 1800, in which various aspects and functions discussed herein may be practiced. The distributed computer system 1800 may include one or more computer systems. For example, as illustrated, the distributed computer system 1800 includes three computer systems 1802, 1804 and 1806. As shown, the computer systems 1802, 1804 and 1806 are interconnected by, and may exchange data through, a communication network 1808. The network 1808 may include any communication network through which computer systems may exchange data. To exchange data via the network 1808, the computer systems 1802, 1804, and 1806 and the network 1808 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA IIOP, RMI, DCOM and Web Services.

According to some embodiments, the functions and operations discussed herein for cyber risk remediation can be executed on computer systems 1802, 1804 and 1806 individually and/or in combination. For example, the computer systems 1802, 1804, and 1806 support, for example, participation in a collaborative network. In one alternative, a single computer system (e.g., 1802) can perform the cyber risk remediation techniques. The computer systems 1802, 1804 and 1806 may include personal computing devices such as cellular telephones, smart phones, tablets, “fablets,” etc., and may also include desktop computers, laptop computers, etc.

Various aspects and functions in accordance with embodiments discussed herein may be implemented as specialized hardware or software executing in one or more computer systems including the computer system 1802 shown in FIG. 18. In one embodiment, computer system 1802 is a personal computing device specially configured to execute the processes and/or operations discussed herein. As depicted, the computer system 1802 includes at least one processor 1810 (e.g., a single core or a multi-core processor), a memory 1812, a bus 1814, input/output interfaces (e.g., 1816) and storage 1818. The processor 1810, which may include one or more microprocessors or other types of controllers, can perform a series of instructions that manipulate data. As shown, the processor 1810 is connected to other system components, including a memory 1812, by an interconnection element (e.g., the bus 1814).

The memory 1812 and/or storage 1818 may be used for storing programs and data during operation of the computer system 1802. For example, the memory 1812 may be a relatively high performance, volatile, random access memory such as a dynamic random access memory (DRAM) or static memory (SRAM). In addition, the memory 1812 may include any device for storing data, such as a disk drive or other non-volatile storage device, such as flash memory, solid state, or phase-change memory (PCM). In further embodiments, the functions and operations discussed with respect to cyber risk remediation can be embodied in an application that is executed on the computer system 1802 from the memory 1812 and/or the storage 1818. For example, the application can be made available through an “app store” for download and/or purchase. Once installed or made available for execution, computer system 1802 can be specially configured to execute the functions associated with cyber risk remediation.

Computer system 1802 also includes one or more interfaces 1816 such as input devices (e.g., camera for capturing images), output devices and combination input/output devices. The interfaces 1816 may receive input, provide output, or both. The storage 1818 may include a computer-readable and computer-writeable nonvolatile storage medium in which instructions are stored that define a program to be executed by the processor. The storage 1818 (storage system) also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 1802 may include an operating system that manages at least a portion of the hardware components (e.g., input/output devices, touch screens, cameras, etc.) included in computer system 1802.

One or more processors or controllers, such as processor 1810, may execute an operating system which may be, among others, a Windows-based operating system (e.g., Windows NT, ME, XP, Vista, 7, 8, 10, 11, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed components, or any combination thereof. Various embodiments may be implemented in part as MATLAB functions, scripts, and/or batch jobs. Thus, the invention is not limited to a specific programming language and any suitable programming language could also be used.

Although the computer system 1802 is shown by way of example as one type of computer system upon which various functions for cyber risk remediation may be practiced, aspects and embodiments are not limited to being implemented on the computer system, shown in FIG. 18. Various aspects and functions may be practiced on one or more computers or similar devices having different architectures or components than that shown in FIG. 18.

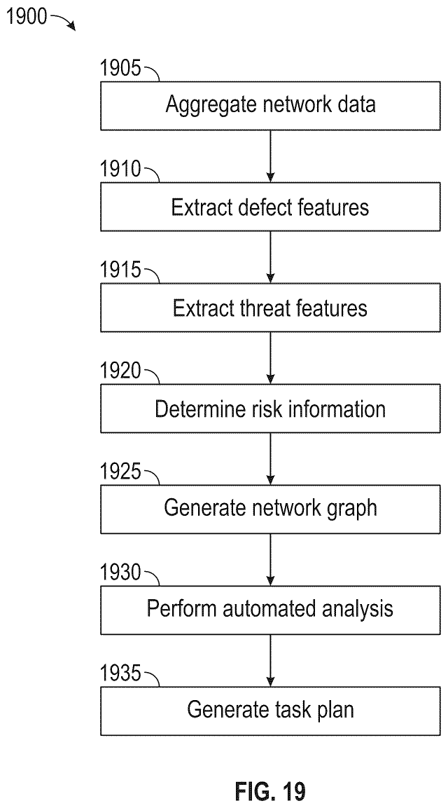

FIG. 19 illustrates an example flowchart of a method 1900 in accordance with one or more embodiments of the present disclosure. The method 2000 may be implemented by the example aspects of a system (e.g., system 300, distributed computer system 1800) described herein.

The method 1900 supports surgically and effectively remediating risk associated with assets (e.g., computing nodes) included in a network in association with increasing risk reduction impact (e.g., maximizing risk reduction impact).

At block 1905, the method 1900 includes aggregating network data associated with the assets included in the network, wherein the assets are associated with an organization. In some aspects, the network data includes network flow information and device connectivity information among the assets.

At block 1910, the method 1900 includes extracting defect features associated with the assets based on control data associated with the network and asset data associated with the assets. In some aspects, the control data includes an indication of software vulnerabilities, device configuration defects, and security tool defects associated with the network. The asset data includes an inventory of the assets and incident data associated with the assets.

At block 1915, the method 1900 includes extracting threat features related to the organization, an industry associated with the organization, or the assets.

At block 1920, the method 1900 includes determining risk information respectively associated with the assets based on the extracted threat features and the extracted defect features. In some aspects, determining the risk information includes mapping the extracted defect features to normalized risk scores using a risk mapping function, and the risk information includes the normalized risk scores.

In a non-limiting example, the method 1900 may include determining a likelihood of a threat associated with an asset included in the network; and determining a control strength associated with the asset and the threat, where the control strength is a measure of an efficacy of a control associated with mitigating the threat. In the example, determining the risk information (at block 1920) includes calculating a risk of exposure for the asset based on: the likelihood of the threat associated with the asset; and the control strength associated with the asset and the threat.

At block 1925, the method 1900 includes generating a network graph based on the aggregated network data and the risk information, where each node in the network graph represents a respective asset included in the network.

In some aspects, the method 1900 may include displaying each node in the network graph with a color indicative of a risk of exposure for an asset represented by the node, where the method includes determining the color according to which to display each node, based on a set of candidate risk indicators and a defined threat model. The method 1900 may include displaying directional arrows between nodes in the network graph, where: a directional arrow between two nodes represents an observed direction of data flow between assets represented by the two nodes, and the directional arrow is displayed with a color and a label according to an amount of the data flow between the two nodes.

At block 1930, the method 1900 includes performing an automated analysis of the network graph.

At block 1935, the method 1900 includes generating a task plan based on performing the automated analysis of the network graph, where generating the task plan includes prioritizing individual assets or sets of connected assets in a defined neighborhood of the network. In an example, the individual assets or the sets of connected assets in the defined neighborhood have a relatively high risk and high importance compared to other assets included in the defined neighborhood.

In some aspects, the task plan maximizes risk reduction impact through the prioritization of individual assets or sets of connected assets.

In an example, the method 1900 may include identifying, based on performing the automated analysis (at block 1930), a target area of the network graph having a risk density which exceeds a threshold risk density, and the task plan (generated at block 1935) may include one or more actions associated with reducing risk with respect to the target area. In the example, the target area is a closed k-neighborhood of a node included in the network graph, and the risk density of the target area is based on a concentration of risks associated with other nodes included in the target area, wherein the other nodes are directly or indirectly connected to the node within a defined distance which defines the closed k-neighborhood.

In an example, the method 1900 may include identifying, based on performing the automated analysis (at block 1930), a target node which is included in the network graph and has a risk propagation value which exceeds a threshold risk propagation value. In the example, the risk propagation value is a measure of a degree of a risk spreading through the network graph via the target node, and the task plan (generated at block 1935) may include one or more actions associated with reducing risk with respect to the target node.

In an example, the method 1900 may include identifying, based on performing the automated analysis (at block 1930), a target area of the network graph including nodes having respective control deficiencies similar to one another. In the example, the task plan (generated at block 1935) may include one or more actions associated with reducing risk with respect to the target area.

In an example, the method 1900 may include determining, based on performing the automated analysis (at block 1930), one or more actions associated with reducing the risk with respect to the network, determining a probability of an adverse impact associated with implementing the one or more actions, and incorporating (at block 1935) the one or more actions into the task plan based on the probability.

In an example, the method 1900 may include determining an asset importance for each asset included among the assets using a crown-centrality measure, wherein the crown-centrality measure is based on a proximity of the asset to a target asset among the assets, where the target asset has one or more of a relatively highest value, a relatively highest strategic importance, or a relatively highest performance compared to remaining assets among the assets. In the example, generating the task plan (at block 1935) may based on the asset importances determined for the assets.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of surgically and effectively remediating risk associated with assets comprised in a network in association with increasing risk reduction impact, comprising:
aggregating network data associated with the assets comprised in the network, wherein the assets are associated with an organization;
extracting defect features associated with the assets based on control data associated with the network and asset data associated with the assets;
extracting threat features related to the organization, an industry associated with the organization, or the assets;
determining risk information respectively associated with the assets based on the extracted threat features and the extracted defect features;
generating a network graph based on the aggregated network data and the risk information, wherein each node in the network graph represents a respective asset comprised in the network;
performing an automated analysis of the network graph; and
generating a task plan based on performing the automated analysis of the network graph, wherein generating the task plan comprises prioritizing individual assets or sets of connected assets in a defined neighborhood of the network.

2. The method of claim 1, wherein the network data comprises network flow information and device connectivity information among the assets.

3. The method of claim 1, wherein:
the control data comprises an indication of software vulnerabilities, device configuration defects, and security tool defects associated with the network, and
the asset data comprises an inventory of the assets and incident data associated with the assets.

4. The method of claim 1, wherein:
determining the risk information comprises mapping the extracted defect features to normalized risk scores using a risk mapping function, and
the risk information comprises the normalized risk scores.

5. The method of claim 1, wherein the individual assets or the sets of connected assets in the defined neighborhood have a relatively high risk and high importance compared to other assets comprised in the defined neighborhood.

6. The method of claim 1, further comprising:
determining a likelihood of a threat associated with an asset comprised in the network; and
determining a control strength associated with the asset and the threat, wherein the control strength is a measure of an efficacy of a control associated with mitigating the threat,
wherein determining the risk information comprises calculating a risk of exposure for the asset based on:
the likelihood of the threat associated with the asset; and
the control strength associated with the asset and the threat.

7. The method of claim 1, further comprising:
displaying each node in the network graph with a color indicative of a risk of exposure for an asset represented by the node, wherein the method comprises determining the color according to which to display each node, based on a set of candidate risk indicators and a defined threat model; and
displaying directional arrows between nodes in the network graph, wherein:
a directional arrow between two nodes represents an observed direction of data flow between assets represented by the two nodes, and
the directional arrow is displayed with a color and a label according to an amount of the data flow between the two nodes.

8. The method of claim 1, further comprising identifying, based on performing the automated analysis, a target area of the network graph having a risk density which exceeds a threshold risk density, wherein the task plan comprises one or more actions associated with reducing risk with respect to the target area.

9. The method of claim 8, wherein:
the target area is a closed k-neighborhood of a node comprised in the network graph; and
the risk density of the target area is based on a concentration of risks associated with other nodes comprised in the target area, wherein the other nodes are directly or indirectly connected to the node within a defined distance which defines the closed k-neighborhood.

10. The method of claim 1, further comprising:
identifying, based on performing the automated analysis, a target node which is included in the network graph and has a risk propagation value which exceeds a threshold risk propagation value, wherein the risk propagation value is a measure of a degree of a risk spreading through the network graph via the target node,
wherein the task plan comprises one or more actions associated with reducing risk with respect to the target node.

11. The method of claim 1, further comprising identifying, based on performing the automated analysis, a target area of the network graph comprising nodes having respective control deficiencies similar to one another,
wherein the task plan comprises one or more actions associated with reducing risk with respect to the target area.

12. The method of claim 1, further comprising:
determining, based on performing the automated analysis, one or more actions associated with reducing the risk with respect to the network;
determining a probability of an adverse impact associated with implementing the one or more actions; and
incorporating the one or more actions into the task plan based on the probability.

13. The method of claim 1, further comprising:
determining an asset importance for each asset comprised among the assets using a crown-centrality measure, wherein the crown-centrality measure is based on a proximity of the asset to a target asset among the assets, wherein the target asset has one or more of a relatively highest value, a relatively highest strategic importance, or a relatively highest performance compared to remaining assets among the assets,
wherein generating the task plan is based on the asset importances determined for the assets.

14. A system configured to:
aggregate network data associated with assets comprised in a network, wherein the assets are associated with an organization;
extract defect features associated with the assets based on control data associated with the network and asset data associated with the assets;
extract threat features related to the organization, an industry associated with the organization, or the assets;
determine risk information respectively associated with the assets based on the extracted threat features and the extracted defect features;
generate a network graph based on the aggregated network data and the risk information, wherein each node in the network graph represents a respective asset comprised in the network;
perform an automated analysis of the network graph; and
generate a task plan based on performing the automated analysis of the network graph, wherein in generating the task plan, the system is configured to prioritize individual assets or sets of connected assets in a defined neighborhood of the network.

15. The system of claim 14, wherein the network data comprises network flow information and device connectivity information among the assets.

16. The system of claim 14, wherein:
the control data comprises an indication of software vulnerabilities, device configuration defects, and security tool defects associated with the network, and
the asset data comprises an inventory of the assets and incident data associated with the assets.

17. The system of claim 14, wherein:
determining the risk information comprises mapping the extracted defect features to normalized risk scores using a risk mapping function, and
the risk information comprises the normalized risk scores.

18. The system of claim 14, wherein the individual assets or the sets of connected assets in the defined neighborhood have a relatively high risk and high importance compared to other assets comprised in the defined neighborhood.

19. The system of claim 14, further comprising identifying, based on performing the automated analysis, at least one of:
a target area of the network graph having a risk density which exceeds a threshold risk density;
a target node which is included in the network graph and has a risk propagation value which exceeds a threshold risk propagation value, wherein the risk propagation value is a measure of a degree of a risk spreading through the network graph via the target node; or
a second target area of the network graph comprising nodes having respective control deficiencies similar to one another,
wherein the task plan comprises one or more actions associated with reducing risk with respect to the at least one of the target area, the target node, or the second target area.

20. An apparatus comprising:
a memory having computer readable instructions and one or more processors for executing the computer readable instructions, wherein the computer readable instructions, when executed by the one or more processors, cause the apparatus to:
aggregate network data associated with assets comprised in a network, wherein the assets are associated with an organization;
extract defect features associated with the assets based on control data associated with the network and asset data associated with the assets;
extract threat features related to the organization, an industry associated with the organization, or the assets;
determine risk information respectively associated with the assets based on the extracted threat features and the extracted defect features;
generate a network graph based on the aggregated network data and the risk information, wherein each node in the network graph represents a respective asset comprised in the network;
perform an automated analysis of the network graph; and
generate a task plan based on performing the automated analysis of the network graph, wherein in generating the task plan, the apparatus is configured to prioritize individual assets or sets of connected assets in a defined neighborhood of the network.
